(19) United States
(12) Patent Application Publication
(10) Pub. No.: US 2021/0076244 A1
(43) Pub. Date: Mar. 11, 2021

(54) INFORMATION SENDING METHOD, INFORMATION RECEIVING METHOD, AND APPARATUS

(71) Applicant: Huawei Technologies Co., Ltd., Shenzhen (CN)

(72) Inventors: Xiaolei TIE, Shanghai (CN); Zhihu LUO, Beijing (CN); Qiming LI, Shenzhen (CN); Zhe JIN, Beijing (CN)

(21) Appl. No.: 17/062,303

(22) Filed: Oct. 2, 2020

Related U.S. Application Data
(63) Continuation of application No. PCT/CN2018/082028, filed on Apr. 4, 2018.

(51) Int. Cl. H04W 24/10; H04W 74/08

(52) U.S. Cl. CPC H04W 24/10; H04W 74/0833

(57) ABSTRACT

An information sending method, an information receiving method, and an apparatus are provided. The information sending method includes: generating a downlink channel quality report volume, where the downlink channel quality report volume is used to indicate a relative relationship between a first number of repetitions and a second number of repetitions, the first number of repetitions is a quantity of retransmissions that need to be performed in a preset downlink control channel format to achieve a preset block error rate, and the second number of repetitions is a number of repetitions corresponding to common search space of a downlink control channel carried on a downlink carrier; and sending an MSG3 to a network device in a random access procedure, where the MSG3 is used to indicate the downlink channel quality report volume.

### CROSS-REFERENCE TO RELATED APPLICATIONS

This application is a continuation of International Application No. PCT/CN2018/082028, filed on Apr. 4, 2018, the disclosure of which is hereby incorporated by reference in its entirety.

### TECHNICAL FIELD

This application relates to the field of mobile communications technologies, and in particular, to an information sending method, an information receiving method, and an apparatus.

### BACKGROUND

Mobile communications have profoundly changed people's life. However, people's pursuit for higher-performance mobile communications will never stop. To cope with an explosive increase of mobile data traffic, massive device connections, and various constantly emerging new services and application scenarios in the future, a fifth generation mobile communications technology (5G) system emerges. As a part of 5G, the internet of things is also increasingly demanded by the market. Currently, in a 3rd generation partnership project (3GPP) standard, solutions have proposed according to characteristics of the internet of things based on a cellular network. For example, a narrowband internet of things (NB-IoT) system carries an IoT service based on a characteristic of a narrowband technology. The NB-IoT system uses a new air interface technology that is independent of an existing cellular network (long term evolution (LTE)), and a terminal device requires lower costs and supports a lower rate and lower mobility.

The NB-IoT system needs to support a very large coverage area, and a base station may use completely different scheduling policies for user equipment (UE) in different communication environments. To ensure communication reliability and save a transmit power of the base station, UEs with different channel conditions need to be differentiated, to facilitate scheduling by the base station. Therefore, a concept of coverage level is introduced into the NB-IoT system. UEs at a same coverage level have similar channel transmission conditions, the base station may use similar scheduling parameters for the UEs, and these UEs have similar control signaling overheads.

Currently, in an NB-IoT system of Rel-13 or Rel-14, a coverage level is defined as follows: A base station provides, in system information, a reference signal received power (RSRP) decision threshold for differentiating between coverage levels. The RSRP decision threshold is mainly determined by the base station based on an uplink interference status. UE determines, based on the RSRP decision threshold, a coverage level at which the UE is located, and selects a random access resource corresponding to the coverage level during random access.

When performing scheduling for a terminal device, the base station performs scheduling based on a resource corresponding to a coverage level at which the terminal device is located. However, currently, when determining the RSRP decision threshold, the base station cannot obtain more information, and can use only the uplink interference status as a reference. Therefore, currently, the RSRP decision threshold is determined by the base station merely based on the uplink interference status. The RSRP decision threshold determined in this manner may be inaccurate, and consequently a coverage level determined by UE is also inaccurate. Therefore, the base station needs more information when performing scheduling for the terminal device.

### SUMMARY

Embodiments of this application provide an information sending method, an information receiving method, and an apparatus, to provide information for scheduling for a terminal device.

According to a first aspect, a first information sending method is provided. The method may be performed by a communications apparatus. The communications apparatus is a terminal device, a chip in a terminal device, or the like. The method may include: generating a downlink channel quality report volume, where the downlink channel quality report volume is used to indicate a relative relationship between a first number of repetitions and a second number of repetitions, the first number of repetitions is a quantity of retransmissions that need to be performed in a preset downlink control channel format to achieve a preset block error rate, and the second number of repetitions is a number of repetitions corresponding to common search space of a downlink control channel carried on a downlink carrier; and sending, to a network device, an MSG3 in a random access procedure, where the MSG3 is used to indicate the downlink channel quality report volume.

Correspondingly, according to a second aspect, a first information receiving method is provided. The method may be performed by a communications apparatus. The communications apparatus is a network device, a chip in a network device, or the like. For example, the network device is a base station. The method includes: receiving, from a terminal device, an MSG3 in a random access procedure; and obtaining a downlink channel quality report volume indicated by the MSG3, where the downlink channel quality report volume is used to indicate a relative relationship between a first number of repetitions and a second number of repetitions, the first number of repetitions is a quantity of retransmissions that need to be performed in a preset downlink control channel format to achieve a preset block error rate, and the second number of repetitions is a number of repetitions corresponding to common search space of a downlink control channel carried on a downlink carrier.

In this embodiment of this application, the downlink channel quality report volume can be obtained and indicated to the network device, so that the network device is provided with more information for scheduling for the terminal device. In this way, when performing scheduling for the terminal device, in addition to considering a coverage level at which the terminal device is located, the network device may further consider downlink channel quality of the terminal device, so that the network device can comprehensively balance an uplink status against a downlink status when performing scheduling for the terminal device. This helps reduce waste of resources and improve scheduling accuracy and rationality.

In addition, in this embodiment of this application, the downlink channel quality report volume is used to indicate the relative relationship between the first number of repetitions and the second number of repetitions. This is equivalent that the downlink channel quality report volume of the terminal device is represented by a quantized value. Compared with direct sending of the first number of repetitions, sending of the quantized value requires far fewer bits. This helps save transmission resources. In addition, a quantity of bits that are in the MSG3 and that can be used to indicate the downlink channel quality report volume is also limited. According to the technical solution in this embodiment of this application, an objective of indicating the downlink channel quality report volume by using the limited bits in the MSG3 can also be achieved, thereby improving resource utilization.

In a possible design, the downlink carrier is an anchor carrier, or the downlink carrier is a carrier for sending an MSG2 in the random access procedure.

In this embodiment of this application, the terminal device may obtain the second number of repetitions by using different downlink carriers. A manner of obtaining the second number of repetitions by using the anchor carrier is relatively simple, while a manner of obtaining the second number of repetitions by using the carrier for sending the MSG2 can ensure that the obtained second number of repetitions is more accurate and more consistent with an actual situation.

In a possible design,

the downlink carrier is an anchor carrier, and the second number of repetitions is a maximum number of repetitions corresponding to common search space of a downlink control channel carried on the anchor carrier; or

the downlink carrier is a first carrier, and the first carrier is the carrier for sending the MSG2; and the second number of repetitions is a number of repetitions of a downlink control channel carried on the first carrier, where the downlink control channel is used for scheduling for the MSG2, or the second number of repetitions is a maximum number of repetitions corresponding to common search space of the downlink control channel carried on the first carrier.

The second number of repetitions may vary with the downlink carrier. In addition, when the downlink carrier is the first carrier, the second number of repetitions may be the number of repetitions of the downlink control channel carried on the first carrier, or may be the maximum number of repetitions corresponding to the common search space of the downlink control channel carried on the first carrier. This is relatively flexible.

In a possible design, when the second number of repetitions is the number of repetitions of the downlink control channel carried on the first carrier, the method further includes: receiving, from the network device on the first carrier, DCI carried on the downlink control channel that is used for scheduling for the MSG2; and obtaining the second number of repetitions from the DCI.

The foregoing describes a manner of obtaining the second number of repetitions by the terminal device.

In a possible design, the method includes: before a first message MSG1 in the random access procedure is sent, performing measurement on a downlink anchor carrier, to obtain the first number of repetitions; or after an MSG1 in the random access procedure is sent, performing measurement on the downlink carrier for sending the MSG2 in the random access procedure, to obtain the first number of repetitions.

There may also be different manners of obtaining the first number of repetitions. The terminal device may obtain the first number of repetitions based on the measurement on the downlink anchor carrier, or may obtain the first number of repetitions based on the measurement on the downlink carrier for sending the MSG2. This is not specifically limited.

In a possible design,

the performing measurement on a downlink anchor carrier, to obtain the first number of repetitions may include: obtaining a first signal to interference plus noise ratio of the anchor carrier through measurement, and determining the first number of repetitions based on the first signal to interference plus noise ratio; or

the performing measurement on the downlink carrier for sending the MSG2 in the random access procedure, to obtain the first number of repetitions may include: obtaining, through measurement, a second signal to interference plus noise ratio of the downlink carrier for sending the MSG2 in the random access procedure; and determining the first number of repetitions based on the second signal to interference plus noise ratio.

For example, the terminal device may determine the first number of repetitions by measuring a signal to interference plus noise ratio of the downlink carrier. For example, the terminal device may preset a mapping relationship between a signal to interference plus noise ratio and a number of repetitions. After obtaining, through measurement, the first signal to interference plus noise ratio of the anchor carrier or obtaining, through measurement, the second signal to interference plus noise ratio of the downlink carrier for sending the MSG2, the terminal device can determine the first number of repetitions by querying the mapping relationship.

In a possible design, the relative relationship is used to represent a ratio between the first number of repetitions and the second number of repetitions, and the downlink channel quality report volume is a quantized value of the ratio.

A manner of obtaining the downlink channel quality report volume is described. In this manner, the terminal device may calculate the ratio between the first number of repetitions and the second number of repetitions, obtain the quantized value of the ratio, and use the quantized value as the downlink channel quality report volume. For example, the terminal device may maintain a value list. After obtaining the ratio, the terminal device selects, from the preset value list, a quantized value corresponding to the ratio. The quantized value corresponding to the ratio may be a quantized value having a smallest difference with the ratio. The quantized value is used to represent the downlink channel quality report volume, that is, represent the downlink channel quality of the terminal device.

In a possible design, the relative relationship is used to represent a value obtained by converting a ratio between the first number of repetitions and the second number of repetitions, and the downlink channel quality report volume is a quantized value of the value obtained through conversion.

Another manner of obtaining the downlink channel quality report volume is described. In this manner, the terminal device may calculate the ratio between the first number of repetitions and the second number of repetitions, convert the ratio into another value, obtain a quantized value of the another value, and use the quantized value as the downlink channel quality report volume. For example, a conversion manner may be multiplying the ratio between first number of repetitions and the second number of repetitions by a coefficient, to obtain another value obtained by converting the ratio. For example, the coefficient is P, where P represents a power factor, and the power factor is a ratio between an NRS power of a downlink carrier corresponding to a random access resource configured for the MSG1 in the random access procedure and an NRS power of the downlink anchor carrier. Moreover, the terminal device may maintain a value list. After obtaining the another value obtained by converting the ratio, the terminal device selects, from the preset value list, a quantized value corresponding to the another value. The quantized value corresponding to the another value may be a quantized value having a smallest difference with the another value. The quantized value is used to represent the downlink channel quality report volume, that is, represent the downlink channel quality of the terminal device.

This manner of obtaining the downlink channel quality report volume is more suitable for a case in which the terminal device determines the first number of repetitions by using the downlink anchor carrier. This can be construed as follows: The terminal device determines the first number of repetitions by performing measurement on the downlink anchor carrier, but a downlink control channel that carries information such as the MSG2 and that is actually received by the terminal device may not be the downlink control channel used by the terminal device to determine the first number of repetitions. Therefore, to reduce an error, a concept of power factor may be introduced, and power compensation is performed by using the power factor. Alternatively, this can be construed as being equivalent to the following: The first number of repetitions determined based on the downlink anchor carrier is converted into the first number of repetitions determined based on the downlink carrier on which the MSG2 is located, so that the finally determined first number of repetitions is more accurate and therefore the downlink channel quality report volume obtained through calculation is also more accurate.

In a possible design, a plurality of bits in the MSG3 are used to indicate the downlink channel quality report volume, and the plurality of bits are in a non-all-zeroed state.

In this embodiment of this application, the plurality of bits in the MSG3 not only can indicate the downlink channel quality report volume, but also can be used to indicate that the terminal device does not support reporting of the downlink channel quality, or indicate that the terminal device does not report the downlink channel quality report volume this time. For example, the plurality of bits in the MSG3 are set to a state. For example, the state is a state in which all of the plurality of bits are set to 0, and it is specified that if the state of the plurality of bits is an all-zeroed state, it indicates that the terminal device does not support reporting of the downlink channel quality, or it indicates that the terminal device does not report the downlink channel quality this time. In this case, it can be considered that the all-0 state of the plurality of bits is a reserved state, and another state of the plurality of bits, that is, a non-all-0 state, can be used to indicate a corresponding downlink channel quality report volume. In this case, if the terminal device determines that the terminal device does not support reporting of the downlink channel quality or determines not to report the downlink channel quality this time, the terminal device may set the plurality of bits in the MSG3 to an all-0 state. However, if the terminal device obtains the downlink channel quality report volume through calculation, determines that the terminal device supports reporting of the downlink channel quality, and determines to report the downlink channel quality this time, the terminal device may set the plurality of bits to a corresponding state based on the downlink channel quality report volume. In this case, the state of the plurality of bits is a non-all-zeroed state.

In a possible design, the downlink channel quality report volume is within a preset range, or the downlink channel quality report volume is greater than or equal to a preset channel quality threshold.

In this embodiment of this application, after obtaining the downlink channel quality report volume, the terminal device may perform evaluation, to determine whether to report the downlink channel quality this time. For example, a preset range may be set in advance, or a channel quality threshold may be set in advance. If the downlink channel quality report volume obtained through calculation by the terminal device is within the preset range, or the downlink channel quality report volume obtained through calculation by the terminal device is greater than or equal to the preset channel quality threshold, the terminal device determines to indicate the downlink channel quality report volume to the network device by using the MSG3. Alternatively, if the downlink channel quality report volume obtained through calculation by the terminal device is outside the preset range, or the downlink channel quality report volume obtained through calculation by the terminal device is less than the preset channel quality threshold, the terminal device determines not to report the downlink channel quality report volume this time. This can be construed as follows: When the downlink channel quality report volume obtained through calculation is outside the preset range, or the downlink channel quality report volume obtained through calculation is less than the preset channel quality threshold, it indicates that the downlink channel quality of the terminal device is relatively good. In this case, little impact may be created even if the network device does not consider the downlink channel quality of the terminal device when determining an RSRP decision threshold. Therefore, in this case, the terminal device may choose not to report the downlink channel quality report volume. The preset range or the channel quality threshold may be stipulated by a protocol, or may be notified to the terminal device by the network device. This is not specifically limited.

According to a third aspect, a second information sending method is provided. The method may be performed by a communications apparatus. The communications apparatus is a terminal device, a chip in a terminal device, or the like. The method includes: generating a downlink carrier channel quality report volume, where the downlink carrier channel quality report volume is used to represent channel quality of a downlink carrier; and sending, to a network device, a third message MSG3 in a random access procedure, where a plurality of bits in the MSG3 are used to indicate the downlink carrier channel quality report volume, and a state of the plurality of bits is a non-all-zeroed state.

Correspondingly, according to a fourth aspect, a second information receiving method is provided. The method may be performed by a communications apparatus. The communications apparatus is a network device, a chip in a network device, or the like. For example, the network device is a base station. The method includes: receiving, from a terminal device, a third message MSG3 in a random access procedure, where a state of a plurality of bits in the MSG3 is a non-all-zeroed state; and determining, based on the state of the plurality of bits, a downlink carrier channel quality report volume indicated by the terminal device, where the downlink carrier channel quality report volume is used to represent channel quality of a downlink carrier.

In the foregoing manner of this embodiment, when a carrier for sending an MSG1 is an anchor carrier, a downlink carrier for sending an MSG2 is also a downlink anchor carrier. In this case, the terminal device performs measurement on the anchor carrier, to obtain channel quality information of the anchor carrier, for determining an MSG4 for which scheduling is to be performed subsequently on the anchor carrier and determining number of repetitions and MCSs for subsequent transmission of a PDCCH and a PDSCH. This resolves a problem that reported channel quality information does not match channel quality of a downlink carrier of the MSG4 and channel quality of a downlink carrier on which the PDCCH and the PDSCH are subsequently located.

In the foregoing manner of this embodiment, when a carrier for sending an MSG1 is a non-anchor carrier, a downlink carrier for sending an MSG2 may be a downlink anchor carrier or may be a downlink non-anchor carrier. In this case, after sending the MSG1, the terminal performs measurement on the downlink carrier for sending the MSG2 to obtain downlink channel quality, and reports the downlink channel quality by using the MSG3, for determining an MSG4 for which scheduling is to be performed subsequently on an anchor carrier and determining number of repetitions and MCSs for subsequent transmission of a PDCCH and a PDSCH. This resolves a problem that reported channel quality information does not match channel quality of a downlink carrier of the MSG4 and channel quality of a downlink carrier on which the PDCCH and the PDSCH are subsequently located.

In a possible design, the downlink carrier is an anchor carrier, or the downlink carrier is a carrier for sending the MSG2 in the random access procedure.

The downlink carrier is not limited in this embodiment of this application. In other words, the terminal device may indicate channel quality of different downlink carriers to the network device.

In a possible design, the generating a downlink carrier channel quality report volume includes:

before the MSG1 in the random access procedure is sent, performing measurement on the anchor carrier, to obtain the downlink carrier channel quality report volume; or

after the MSG1 in the random access procedure is sent, performing measurement on the carrier for sending the MSG2 in the random access procedure, to obtain the downlink carrier channel quality report volume.

A manner of generating the downlink carrier channel quality report volume varies with the downlink carrier.

In a possible design,

the performing measurement on the anchor carrier, to obtain the downlink carrier channel quality report volume includes: obtaining a first signal to interference plus noise ratio of the anchor carrier through measurement, and determining the downlink carrier channel quality report volume based on the first signal to interference plus noise ratio; or

the performing measurement on the carrier for sending the MSG2 in the random access procedure, to obtain the downlink carrier channel quality report volume includes: obtaining, through measurement, a second signal to interference plus noise ratio of the downlink carrier for sending the MSG2 in the random access procedure, and determining the downlink carrier channel quality report volume based on the second signal to interference plus noise ratio.

For example, the terminal device may determine the downlink carrier channel quality report volume by measuring the signal to interference plus noise ratio of the downlink carrier. This manner is relatively simple.

In a possible design, before the terminal device sends the MSG3 to the network device in the random access procedure, the method further includes: receiving N channel quality thresholds configured by the network device, determining N+1 channel quality intervals based on the N channel quality thresholds, determining that the N+1 channel quality intervals are in a one-to-one correspondence with N+1 non-all-0 states of the plurality of bits in the MSG3, and setting the state of the plurality of bits to a state corresponding to a channel quality interval into which the downlink carrier channel quality report volume falls. Correspondingly, before the network device receives the MSG3 from the terminal device in the random access procedure, the method further includes: sending the N channel quality thresholds to the terminal device, where the N channel quality thresholds are used by the terminal device to set the state of the plurality of bits.

Configuring the N channel quality thresholds for the terminal device by the network device is equivalent that the channel quality intervals are in a one-to-one correspondence with states of the plurality of bits. Therefore, after obtaining the downlink channel quality report volume, the terminal device can set the state of the plurality of bits based on the channel quality interval into which the downlink channel quality report volume falls. This provides an implementation for setting the state of the plurality of bits in the MSG3.

In a possible design, after the generating a downlink carrier channel quality report volume, and before the sending an MSG3 to a network device, the method further includes: updating the downlink channel quality report volume indicated by the plurality of bits in the MSG3.

The random access procedure may be relatively long. During the random access procedure, the terminal device may make a plurality of random access attempts. If the downlink carrier channel quality report volume indicated by the terminal device is never updated, a current channel attenuation status and the like cannot be reflected relatively accurately. Considering this kind of problem, in this embodiment of this application, the downlink carrier channel quality report volume may be updated. In this way, the downlink carrier channel quality report volume indicated by the terminal device can reflect a current channel attenuation status and the like in a relatively timely and more accurate manner.

According to a fifth aspect, a third information sending method is provided. The method may be performed by a communications apparatus. The communications apparatus is a terminal device, a chip inside a terminal device, or the like. The method includes: generating an MSG3 in a random access procedure; setting a state of a plurality of bits in the MSG3 to an all-zeroed state based on a preset condition, where the all-zeroed state is used to indicate that reporting of channel quality of a downlink carrier is not supported, or used to indicate that the channel quality of the downlink carrier is not reported this time; and sending the MSG3 to a network device.

Correspondingly, according to a sixth aspect, a third information receiving method is provided. The method may be performed by a communications apparatus. The communications apparatus is a network device, a chip inside a network device, or the like. For example, the network device is a base station. The method includes: receiving, from a terminal device, an MSG3 in a random access procedure; determining that a state of a plurality of bits in the MSG3 is an all-zeroed state; and determining, based on the all-zeroed state, that the terminal device does not support reporting of channel quality of a downlink carrier, or that the terminal device does not report the channel quality of the downlink carrier this time.

If the terminal device does not support reporting of the channel quality of the downlink carrier, or the terminal device does not report the channel quality of the downlink carrier this time, the terminal device does not need to occupy a non-all-0 state of the plurality of bits of the MSG3, and can give an indication by using the all-0 state of the plurality of bits. This further saves a non-all-0 state, thereby achieving a finer reporting granularity of a downlink carrier channel quality report volume.

In a possible design, the preset condition includes: when the downlink carrier is a non-anchor carrier, setting the state of the plurality of bits in the MSG3 to an all-zeroed state.

In a possible design, the preset condition includes: generating the downlink carrier channel quality report volume before generating the MSG3, where the downlink carrier channel quality report volume is used to represent the channel quality of the downlink carrier; and determining that the downlink carrier channel quality report volume is outside a preset range, or determining that the downlink carrier channel quality report volume is less than a preset channel quality threshold, and setting the state of the plurality of bits in the MSG3 to an all-zeroed state.

These two preset conditions may exist alone or coexist.

According to a seventh aspect, a fourth information sending method is provided. The method may be performed by a communications apparatus. The communications apparatus is a terminal device, a chip inside a terminal device, or the like. The method includes: determining to-be-sent information, where the to-be-sent information is one of a downlink channel quality report volume and a power headroom level, and the downlink channel quality report volume is used to represent downlink channel quality; and sending, to a network device, an MSG3 in a random access procedure, where a plurality of bits in the MSG3 are used to indicate the to-be-sent information.

Correspondingly, according to an eighth aspect, a fourth information receiving method is provided. The method may be performed by a communications apparatus. The communications apparatus is a network device, a chip inside a network device, or the like. For example, the network device is a base station. The method includes: receiving, from a terminal device, an MSG3 in a random access procedure; and determining, based on a state of a plurality of bits in the MSG3, whether to-be-sent information indicated by the MSG3 is a downlink channel quality report volume or a power headroom level, where the downlink channel quality report volume is used to represent downlink channel quality of the terminal device.

The MSG3 not only can be used to indicate a downlink carrier channel quality report volume, but also can be used to indicate a power headroom level of an enhanced PH. If both the downlink channel quality report volume and the power headroom level of the enhanced PH need to be reported, this embodiment of this application provides a solution, to avoid a conflict and ensure, as far as possible, that at least one of the downlink channel quality report volume and the power headroom level of the enhanced PH can be reported normally.

In a possible design, that the terminal device determines the to-be-sent information includes: determining, as the to-be-sent information, one of the downlink channel quality report volume and the power headroom level that has a higher priority, where a priority of the downlink channel quality report volume is higher than a priority of the power headroom level, or the priority of the power headroom level is higher than the priority of the downlink channel quality report volume. Correspondingly, the to-be-sent information is information of the downlink channel quality report volume and the power headroom level that has a higher priority, where the priority of the downlink channel quality report volume is higher than the priority of the power headroom level, or the priority of the power headroom level is higher than the priority of the downlink channel quality report volume.

The priority of the downlink channel quality report volume and the priority of the power headroom level of the enhanced PH may be stipulated in advance, and the terminal device reports the information that has a higher priority. For example, it is stipulated that the priority of the downlink channel quality report volume is higher than the priority of the power headroom level of the enhanced PH. In this case, the terminal device determines that the to-be-sent information is the downlink channel quality report volume. Alternatively, it is stipulated that the priority of the power headroom level of the enhanced PH is higher than the priority of the downlink channel quality report volume. In this case, the terminal device determines that the to-be-sent information is the power headroom level of the enhanced PH. If a priority of one type of information is higher, it indicates that the information may be more important. In this case, the terminal device chooses to report the information that has a higher priority, so that the important information can be transmitted in a relatively timely manner.

In a possible design, before the terminal device sends the MSG3 to the network device in the random access procedure, the method further includes: setting a state of some bits in the plurality of bits based on the to-be-sent information, where the state of the some bits is used to indicate that the to-be-sent information is the downlink channel quality report volume or the power headroom level. Correspondingly, that the network device determines, based on the state of the plurality of bits in the MSG3, the to-be-sent information indicated by the MSG3 is the downlink channel quality report volume or the power headroom level includes: determining, based on the state of the some bits in the plurality of bits, that the to-be-sent information indicated by the MSG3 is the downlink channel quality report volume or the power headroom level.

The terminal device may choose to report the downlink channel quality report volume or the power headroom level. For example, the terminal device may choose the downlink channel quality report volume or the power headroom level randomly, or the terminal device may choose to report the downlink channel quality report volume and the power headroom level in turn. For example, the terminal device first chooses to report the downlink channel quality report volume, and next time, chooses to report the power headroom level. Alternatively, the terminal device may use another choosing manner. The choice is made by the terminal device. Therefore, the terminal device may indicate, to the network device by using some bits in the plurality of bits, whether the MSG3 indicates the downlink channel quality report volume or the power headroom level. After receiving the MSG3, the network device may determine, based on the state of the some bits in the plurality of bits, whether the terminal device indicates the downlink channel quality report volume or the power headroom level by using the MSG3. In this way, the terminal device can be kept consistent with the network device.

In a possible design, that the terminal device determines the to-be-sent information includes: receiving indication information from the network device; and determining, based on the indication information, whether the to-be-sent information is the downlink channel quality report volume or the power headroom level. Correspondingly, before the network device receives the MSG3 from the terminal device in the random access procedure, the method further includes: sending the indication information to the terminal device, where the indication information is used to indicate whether the to-be-sent information is the downlink channel quality report volume or the power headroom level.

The network device instructs, by using the indication information, the terminal device to report the downlink channel quality report volume or the power headroom level. The terminal device can determine, based on the indication information sent by the network device, whether to report the downlink channel quality report volume or the power headroom level. The indication information may be implemented by using a system message or implemented by using an MSG2 in the random access procedure, or may be implemented by using another message. In this way, the terminal device can be kept consistent with the network device. In addition, the information that the network device instructs the terminal device to report may be information just required by the network device, and the terminal device reporting the information based on the instruction from the network device can also make the reported information more compliant with a requirement of the network device.

According to a ninth aspect, a communications apparatus is provided. For example, the communications apparatus is a terminal device. The terminal device has functions of implementing the terminal device in the foregoing method designs. These functions may be implemented by hardware, or may be implemented by hardware executing corresponding software. The hardware or software includes one or more units corresponding to the foregoing functions.

In a possible design, a structure of the terminal device may include a processor and a transceiver. The processor and the transceiver may perform corresponding functions in the method according to any one of the first aspect or the possible designs of the first aspect.

According to a tenth aspect, a communications apparatus is provided. For example, the communications apparatus is a network device. The network device has functions of implementing the network device in the foregoing method designs. These functions may be implemented by hardware, or may be implemented by hardware executing corresponding software. The hardware or software includes one or more units corresponding to the foregoing functions.

In a possible design, a structure of the network device may include a processor and a transceiver. The processor and the transceiver may perform corresponding functions in the method according to any one of the second aspect or the possible designs of the second aspect.

According to an eleventh aspect, a communications apparatus is provided. For example, the communications apparatus is a terminal device. The terminal device has functions of implementing the terminal device in the foregoing method designs. These functions may be implemented by hardware, or may be implemented by hardware executing corresponding software. The hardware or software includes one or more units corresponding to the foregoing functions.

In a possible design, a structure of the terminal device may include a processor and a transceiver. The processor and the transceiver may perform corresponding functions in the method according to any one of the third aspect or the possible designs of the third aspect.

According to a twelfth aspect, a communications apparatus is provided. For example, the communications apparatus is a network device. The network device has functions of implementing the network device in the foregoing method designs. These functions may be implemented by hardware, or may be implemented by hardware executing corresponding software. The hardware or software includes one or more units corresponding to the foregoing functions.

In a possible design, a structure of the network device may include a processor and a transceiver. The processor and the transceiver may perform corresponding functions in the method according to any one of the fourth aspect or the possible designs of the fourth aspect.

According to a thirteenth aspect, a communications apparatus is provided. For example, the communications apparatus is a terminal device. The terminal device has functions of implementing the terminal device in the foregoing method designs. These functions may be implemented by hardware, or may be implemented by hardware executing corresponding software. The hardware or software includes one or more units corresponding to the foregoing functions.

In a possible design, a structure of the terminal device may include a processor and a transceiver. The processor and the transceiver may perform corresponding functions in the method according to any one of the fifth aspect or the possible designs of the fifth aspect.

According to a fourteenth aspect, a communications apparatus is provided. For example, the communications apparatus is a network device. The network device has functions of implementing the network device in the foregoing method designs. These functions may be implemented by hardware, or may be implemented by hardware executing corresponding software. The hardware or software includes one or more units corresponding to the foregoing functions.

In a possible design, a structure of the network device may include a processor and a transceiver. The processor and the transceiver may perform corresponding functions in the method according to any one of the sixth aspect or the possible designs of the sixth aspect.

According to a fifteenth aspect, a communications apparatus is provided. For example, the communications apparatus is a terminal device. The terminal device has functions of implementing the terminal device in the foregoing method designs. These functions may be implemented by hardware, or may be implemented by hardware executing corresponding software. The hardware or software includes one or more units corresponding to the foregoing functions.

In a possible design, a structure of the terminal device may include a processor and a transceiver. The processor and the transceiver may perform corresponding functions in the method according to any one of the seventh aspect or the possible designs of the seventh aspect.

According to a sixteenth aspect, a communications apparatus is provided. For example, the communications apparatus is a network device. The network device has functions of implementing the network device in the foregoing method designs. These functions may be implemented by hardware, or may be implemented by hardware executing corresponding software. The hardware or software includes one or more units corresponding to the foregoing functions.

In a possible design, a structure of the network device may include a processor and a transceiver. The processor and the transceiver may perform corresponding functions in the method according to any one of the eighth aspect or the possible designs of the eighth aspect.

According to a seventeenth aspect, a communications apparatus is provided. For example, the communications apparatus is a terminal device. The terminal device has functions of implementing the terminal device in the foregoing method designs. These functions may be implemented by hardware, or may be implemented by hardware executing corresponding software. The hardware or software includes one or more units corresponding to the foregoing functions.

In a possible design, a structure of the terminal device may include a processing module and a transceiver module. The processing module and the transceiver module may perform corresponding functions in the method according to any one of the first aspect or the possible designs of the first aspect.

According to an eighteenth aspect, a communications apparatus is provided. For example, the communications apparatus is a network device. The network device has functions of implementing the network device in the foregoing method designs. These functions may be implemented by hardware, or may be implemented by hardware executing corresponding software. The hardware or software includes one or more units corresponding to the foregoing functions.

In a possible design, a structure of the network device may include a processing module and a transceiver module. The processing module and the transceiver module may perform corresponding functions in the method according to any one of the second aspect or the possible designs of the second aspect.

According to a nineteenth aspect, a communications apparatus is provided. For example, the communications apparatus is a terminal device. The terminal device has functions of implementing the terminal device in the foregoing method designs. These functions may be implemented by hardware, or may be implemented by hardware executing corresponding software. The hardware or software includes one or more units corresponding to the foregoing functions.

In a possible design, a structure of the terminal device may include a processing module and a transceiver module. The processing module and the transceiver module may perform corresponding functions in the method according to any one of the third aspect or the possible designs of the third aspect.

According to a twentieth aspect, a communications apparatus is provided. For example, the communications apparatus is a network device. The network device has functions of implementing the network device in the foregoing method designs. These functions may be implemented by hardware, or may be implemented by hardware executing corresponding software. The hardware or software includes one or more units corresponding to the foregoing functions.

In a possible design, a structure of the network device may include a processing module and a transceiver module. The processing module and the transceiver module may perform corresponding functions in the method according to any one of the fourth aspect or the possible designs of the fourth aspect.

According to a twenty-first aspect, a communications apparatus is provided. For example, the communications apparatus is a terminal device. The terminal device has functions of implementing the terminal device in the foregoing method designs. These functions may be implemented by hardware, or may be implemented by hardware executing corresponding software. The hardware or software includes one or more units corresponding to the foregoing functions.

In a possible design, a structure of the terminal device may include a processing module and a transceiver module. The processing module and the transceiver module may perform corresponding functions in the method according to any one of the fifth aspect or the possible designs of the fifth aspect.

According to a twenty-second aspect, a communications apparatus is provided. For example, the communications apparatus is a network device. The network device has functions of implementing the network device in the foregoing method designs. These functions may be implemented by hardware, or may be implemented by hardware executing corresponding software. The hardware or software includes one or more units corresponding to the foregoing functions.

In a possible design, a structure of the network device may include a processing module and a transceiver module. The processing module and the transceiver module may perform corresponding functions in the method according to any one of the sixth aspect or the possible designs of the sixth aspect.

According to a twenty-third aspect, a communications apparatus is provided. For example, the communications apparatus is a terminal device. The terminal device has functions of implementing the terminal device in the foregoing method designs. These functions may be implemented by hardware, or may be implemented by hardware executing corresponding software. The hardware or software includes one or more units corresponding to the foregoing functions.

In a possible design, a structure of the terminal device may include a processing module and a transceiver module. The processing module and the transceiver module may perform corresponding functions in the method according to any one of the seventh aspect or the possible designs of the seventh aspect.

According to a twenty-fourth aspect, a communications apparatus is provided. For example, the communications apparatus is a network device. The network device has functions of implementing the network device in the foregoing method designs. These functions may be implemented by hardware, or may be implemented by hardware executing corresponding software. The hardware or software includes one or more units corresponding to the foregoing functions.

In a possible design, a structure of the network device may include a processing module and a transceiver module. The processing module and the transceiver module may perform corresponding functions in the method according to any one of the eighth aspect or the possible designs of the eighth aspect.

According to a twenty-fifth aspect, a communications apparatus is provided. The communications apparatus may be the terminal device in the foregoing method designs or a chip provided in the terminal device. The communications apparatus includes: a memory, configured to store computer executable program code; and a processor, where the processor is coupled to the memory. The program code stored in the memory includes an instruction. When the processor executes the instruction, the communications apparatus is enabled to perform the method according to any one of the first aspect or the possible designs of the first aspect.

According to a twenty-sixth aspect, a communications apparatus is provided. The communications apparatus may be the network device in the foregoing method designs or a chip provided in the network device. The communications apparatus includes: a memory, configured to store computer executable program code; and a processor, where the processor is coupled to the memory. The program code stored in the memory includes an instruction. When the processor executes the instruction, the communications apparatus is enabled to perform the method according to any one of the second aspect or the possible designs of the second aspect.

According to a twenty-seventh aspect, a communications apparatus is provided. The communications apparatus may be the terminal device in the foregoing method designs or a chip provided in the terminal device. The communications apparatus includes: a memory, configured to store computer executable program code; and a processor, where the processor is coupled to the memory. The program code stored in the memory includes an instruction. When the processor executes the instruction, the communications apparatus is enabled to perform the method according to any one of the third aspect or the possible designs of the third aspect.

According to a twenty-eighth aspect, a communications apparatus is provided. The communications apparatus may be the network device in the foregoing method designs or a chip provided in the network device. The communications apparatus includes: a memory, configured to store computer executable program code; and a processor, where the processor is coupled to the memory. The program code stored in the memory includes an instruction. When the processor executes the instruction, the communications apparatus is enabled to perform the method according to any one of the fourth aspect or the possible designs of the fourth aspect.

According to a twenty-ninth aspect, a communications apparatus is provided. The communications apparatus may be the terminal device in the foregoing method designs or a chip provided in the terminal device. The communications apparatus includes: a memory, configured to store computer executable program code; and a processor, where the processor is coupled to the memory. The program code stored in the memory includes an instruction. When the processor executes the instruction, the communications apparatus is enabled to perform the method according to any one of the fifth aspect or the possible designs of the fifth aspect.

According to a thirtieth aspect, a communications apparatus is provided. The communications apparatus may be the network device in the foregoing method designs or a chip provided in the network device. The communications apparatus includes: a memory, configured to store computer executable program code; and a processor, where the processor is coupled to the memory. The program code stored in the memory includes an instruction. When the processor executes the instruction, the communications apparatus is enabled to perform the method according to any one of the sixth aspect or the possible designs of the sixth aspect.

According to a thirty-first aspect, a communications apparatus is provided. The communications apparatus may be the terminal device in the foregoing method designs or a chip provided in the terminal device. The communications apparatus includes: a memory, configured to store computer executable program code; and a processor, where the processor is coupled to the memory. The program code stored in the memory includes an instruction. When the processor executes the instruction, the communications apparatus is enabled to perform the method according to any one of the seventh aspect or the possible designs of the seventh aspect.

According to a thirty-second aspect, a communications apparatus is provided. The communications apparatus may be the network device in the foregoing method designs or a chip provided in the network device. The communications apparatus includes: a memory, configured to store computer executable program code; and a processor, where the processor is coupled to the memory. The program code stored in the memory includes an instruction. When the processor executes the instruction, the communications apparatus is enabled to perform the method according to any one of the eighth aspect or the possible designs of the eighth aspect.

According to a thirty-third aspect, a first communications system is provided. The communications system includes a terminal device and a network device. The terminal device is configured to: generate a downlink channel quality report volume, where the downlink channel quality report volume is used to indicate a relative relationship between a first number of repetitions and a second number of repetitions, the first number of repetitions is a quantity of retransmissions that need to be performed in a preset downlink control channel format to achieve a preset block error rate, and the second number of repetitions is a number of repetitions corresponding to common search space of a downlink control channel carried on a downlink carrier; and send, to the network device, an MSG3 in a random access procedure, where the MSG3 is used to indicate the downlink channel quality report volume. The network device is configured to: receive the MSG3 from the terminal device in the random access procedure; and obtain the downlink channel quality report volume indicated by the MSG3, where the downlink channel quality report volume is used to indicate the relative relationship between the first number of repetitions and the second number of repetitions, the first number of repetitions is the quantity of retransmissions that need to be performed in the preset downlink control channel format to achieve the preset block error rate, and the second number of repetitions is the number of repetitions corresponding to the common search space of the downlink control channel carried on the downlink carrier.

According to a thirty-fourth aspect, a second communications system is provided. The communications system includes a terminal device and a network device. The terminal device is configured to: generate a downlink carrier channel quality report volume, where the downlink carrier channel quality report volume is used to represent channel quality of a downlink carrier; and send, to the network device, an MSG3 in a random access procedure, where a plurality of bits in the MSG3 are used to indicate the downlink carrier channel quality report volume, and a state of the plurality of bits is a non-all-zeroed state. The network device is configured to: receive the MSG3 from the terminal device in the random access procedure, where the state of the plurality of bits in the MSG3 is the non-all-zeroed state; and determine, based on the state of the plurality of bits, the downlink carrier channel quality report volume indicated by the terminal device, where the downlink carrier channel quality report volume is used to represent the channel quality of the downlink carrier.

According to a thirty-fifth aspect, a third communications system is provided. The communications system includes a terminal device and a network device. The terminal device is configured to: generate an MSG3 in a random access procedure, where a non-all-zeroed state of a plurality of bits in the MSG3 is used to indicate channel quality of a downlink carrier; and set a state of the plurality of bits in the MSG3 to an all-zeroed state based on a preset condition; and send the MSG3 to the network device. The network device is configured to receive the MSG3 from the terminal device in the random access procedure, where the non-all-zeroed state of the plurality of bits in the MSG3 is used to indicate the channel quality of the downlink carrier; and determine that the state of the plurality of bits in the MSG3 is an all-zeroed state.

According to a thirty-sixth aspect, a fourth communications system is provided. The communications system includes a terminal device and a network device. The terminal device is configured to: determine to-be-sent information, where the to-be-sent information is one of a downlink channel quality report volume and a power headroom level, and the downlink channel quality report volume is used to represent downlink channel quality; and send, to the network device, an MSG3 in a random access procedure, where a plurality of bits in the MSG3 are used to indicate the to-be-sent information. The network device is configured to receive the MSG3 from the terminal device in the random access procedure; and determine, based on a state of the plurality of bits in the MSG3, whether the to-be-sent information indicated by the MSG3 is the downlink channel quality report volume or the power headroom level, where the downlink channel quality report volume is used to represent the downlink channel quality of the terminal device.

The communications system provided in the thirty-third aspect, the communications system provided in the thirty-fourth aspect, the communications system provided in the thirty-fifth aspect, and the communications system provided in the thirty-sixth aspect may be four different communications systems, or at least two of the communications systems may be a same communications system.

According to a thirty-seventh aspect, a computer storage medium is provided. The computer-readable storage medium stores an instruction. When the instruction is run on a computer, the computer is enabled to perform the method according to any one of the first aspect or the possible designs of the first aspect.

According to a thirty-eighth aspect, a computer storage medium is provided. The computer-readable storage medium stores an instruction. When the instruction is run on a computer, the computer is enabled to perform the method according to any one of the second aspect or the possible designs of the second aspect.

According to a thirty-ninth aspect, a computer storage medium is provided. The computer-readable storage medium stores an instruction. When the instruction is run on a computer, the computer is enabled to perform the method according to any one of the third aspect or the possible designs of the third aspect.

According to a fortieth aspect, a computer storage medium is provided. The computer-readable storage medium stores an instruction. When the instruction is run on a computer, the computer is enabled to perform the method according to any one of the fourth aspect or the possible designs of the fourth aspect.

According to a forty-first aspect, a computer storage medium is provided. The computer-readable storage medium stores an instruction. When the instruction is run on a computer, the computer is enabled to perform the method according to any one of the fifth aspect or the possible designs of the fifth aspect.

According to a forty-second aspect, a computer storage medium is provided. The computer-readable storage medium stores an instruction. When the instruction is run on a computer, the computer is enabled to perform the method according to any one of the sixth aspect or the possible designs of the sixth aspect.

According to a forty-third aspect, a computer storage medium is provided. The computer-readable storage medium stores an instruction. When the instruction is run on a computer, the computer is enabled to perform the method according to any one of the seventh aspect or the possible designs of the seventh aspect.

According to a forty-fourth aspect, a computer storage medium is provided. The computer-readable storage medium stores an instruction. When the instruction is run on a computer, the computer is enabled to perform the method according to any one of the eighth aspect or the possible designs of the eighth aspect.

According to a forty-fifth aspect, a computer program product including an instruction is provided. The computer program product stores the instruction. When the computer program product is run on a computer, the computer is enabled to perform the method according to any one of the first aspect or the possible designs of the first aspect.

According to a forty-sixth aspect, a computer program product including an instruction is provided. The computer program product stores the instruction. When the computer program product is run on a computer, the computer is enabled to perform the method according to any one of the second aspect or the possible designs of the second aspect.

According to a forty-seventh aspect, a computer program product including an instruction is provided. The computer program product stores the instruction. When the computer program product is run on a computer, the computer is enabled to perform the method according to any one of the third aspect or the possible designs of the third aspect.

According to a forty-eighth aspect, a computer program product including an instruction is provided. The computer program product stores the instruction. When the computer program product is run on a computer, the computer is enabled to perform the method according to any one of the fourth aspect or the possible designs of the fourth aspect.

According to a forty-ninth aspect, a computer program product including an instruction is provided. The computer program product stores the instruction. When the computer program product is run on a computer, the computer is enabled to perform the method according to any one of the fifth aspect or the possible designs of the fifth aspect.

According to a fiftieth aspect, a computer program product including an instruction is provided. The computer program product stores the instruction. When the computer program product is run on a computer, the computer is enabled to perform the method according to any one of the sixth aspect or the possible designs of the sixth aspect.

According to a fifty-first aspect, a computer program product including an instruction is provided. The computer program product stores the instruction. When the computer program product is run on a computer, the computer is enabled to perform the method according to any one of the seventh aspect or the possible designs of the seventh aspect.

According to a fifty-second aspect, a computer program product including an instruction is provided. The computer program product stores the instruction. When the computer program product is run on a computer, the computer is enabled to perform the method according to any one of the eighth aspect or the possible designs of the eighth aspect.

In the embodiments of this application, when performing scheduling for the terminal device, in addition to considering a coverage level at which the terminal device is located, the network device may further consider the downlink channel quality of the terminal device, so that the network device can comprehensively balance an uplink status against a downlink status when performing scheduling for the terminal device. This helps reduce waste of resources and improve scheduling accuracy and rationality.

### BRIEF DESCRIPTION OF DRAWINGS

FIG. 1 is a schematic diagram of a case in which R in scheduling by a network device may be less than Rmax in a random access procedure;

FIG. 2 is a schematic diagram of an application scenario according to an embodiment of this application;

FIG. 3 is a flowchart of a first information sending and receiving method according to an embodiment of this application;

FIG. 4 is a flowchart of a second information sending and receiving method according to an embodiment of this application;

FIG. 5 is a schematic diagram of a case in which it is assumed that a downlink channel quality report volume is not changed in a random access procedure according to an embodiment of this application;

FIG. 6 is a schematic diagram of a case in which a downlink channel quality report volume is updated in a random access procedure according to an embodiment of this application;

FIG. 7 is a flowchart of a third information sending and receiving method according to an embodiment of this application;

FIG. 8 is a schematic structural diagram of a communications apparatus that can implement a function of a terminal device according to an embodiment of this application;

FIG. 9 is a schematic structural diagram of a communications apparatus that can implement a function of a network device according to an embodiment of this application;

FIG. 10 is a schematic structural diagram of a communications apparatus that can implement a function of a terminal device according to an embodiment of this application;

FIG. 11 is a schematic structural diagram of a communications apparatus that can implement a function of a network device according to an embodiment of this application;

FIG. 12 is a schematic structural diagram of a communications apparatus that can implement a function of a terminal device according to an embodiment of this application;

FIG. 13 is a schematic structural diagram of a communications apparatus that can implement a function of a network device according to an embodiment of this application; and

FIG. 14A and FIG. 14B are two schematic structural diagrams of a communications apparatus that can implement a function of a network device or a terminal device according to an embodiment of this application.

### DESCRIPTION OF EMBODIMENTS

To make the objective, technical solutions, and advantages of the embodiments of this application clearer, the following clearly describes the technical solutions of the embodiments of this application with reference to the accompanying drawings in the embodiments of this application.

In the following, some terms in the embodiments of this application are explained and described, so as to help a person skilled in the art have a better understanding.

1. A terminal device includes a device that provides a user with voice and/or data connectivity, for example, may include a handheld device with a wireless connection function, or a processing device connected to a wireless modem. The terminal device may communicate with a core network via a radio access network (RAN), to exchange voice and/or data with the RAN. The terminal device may include user equipment (UE), a wireless terminal device, a mobile terminal device, a subscriber unit, a subscriber station, a mobile station, a mobile console (mobile), a remote station, an access point (AP), a remote terminal device, an access terminal device, a user terminal device (user terminal), a user agent, a user device, or the like. For example, the terminal device may include a mobile phone (or referred to as a “cellular” phone), a computer with a mobile terminal device, a portable, pocket-sized, handheld, computer built-in, or vehicle-mounted mobile apparatus, or a smart wearable device. For example, the terminal device may be a device such as a personal communications service (PCS) phone, a cordless telephone set, a session initiation protocol (SIP) phone, a wireless local loop (WLL) station, or a personal digital assistant (PDA). The terminal device further includes a restricted device, such as a device with relatively low power consumption, a device with a limited storage capability, or a device with a limited computing capability. For example, the terminal device includes an information sensing device such as a barcode, radio frequency identification (RFID), a sensor, a global positioning system (GPS), or a laser scanner.

As an example rather than a limitation, in the embodiments of this application, the terminal device may alternatively be a wearable device. A wearable device may also be referred to as a wearable smart device, which is a collective term for wearable devices, such as glasses, gloves, watches, clothes, and shoes, that are obtained by performing intellectualized design and development on daily wear by using a wearable technology. A wearable device is a portable device worn directly on the body or integrated into clothes or an accessory of a user. A wearable device is not just a hardware device, but also implements powerful functions through software support, data exchange, and cloud-based exchange. In a broad sense, wearable smart devices include large-sized devices that have comprehensive functions and that can implement complete or some functions independent of a smartphone, for example, a smart watch or smart glasses; and include devices that are intended for only a specific type of application function and that need to be used in coordination with another device such as a smartphone, for example, various types of smart bands, smart helmets, and smart jewelry for vital sign monitoring.

2. A network device includes a base station (for example, an access point) or the like, and may refer to a device in communication with a wireless terminal via one or more cells at an air interface in an access network. The network device may be configured to perform interconversion between a received over-the-air frame and an Internet Protocol (IP) packet and serve as a router between the wireless terminal and a rest portion of the access network, where the rest portion of the access network may include an IP network. The network device may coordinate attribute management of the air interface. For example, the network device may include an evolved nodeB (NodeB, eNB, e-NodeB, evolutional Node B) in a long term evolution (LTE) system or an LTE-advanced (LTE-A) system, may include a next generation node B (gNB) in a fifth generation mobile communications technology (5G) new radio (NR) system, or may include a centralized unit (CU) and a distributed unit (DU) in a cloud radio access network (CloudRAN) system. This is not limited in the embodiments of this application.

3. MTC (machine type communication) is also referred to as machine to machine (M2M) communication or IoT (internet of things), and will become an important application in the communications field in the future. Future internet of things communication may mainly cover intelligent meter reading, medical detection and monitoring, logistics detection, industrial detection and monitoring, internet of vehicles, smart community, wearable device communication, and the like. An internet of vehicles industry forged based on MTC communication is considered as a fourth wave following computers, the Internet, and mobile communications networks and is a developing direction of future networks. It is estimated that a quantity of connected MTC devices will reach 50 billion by the year of 2022.

A communications system based on an existing cellular network infrastructure is an important type of MTC communications system. This type of MTC communication is usually referred to as cellular MTC or cellular IoT (CIoT). The 3rd generation partnership project (3GPP) standardization organization has been paying close attention to development of cellular MTC and has actively carried out standardization of related technologies. A cellular MTC service mainly has the following requirements on a network and UE:

Requirement for a large coverage area: Currently available MTC services usually do not require a very high service rate, but need to be able to support a very large coverage area. The so-called large coverage area means that an MTC base station uses a relatively strong coverage enhancement technology, and a communications service is available to user equipment when a penetration loss is relatively high (20 dB). For example, user equipment in smart household and intelligent meter reading services, for example, a smart water meter and a smart electricity meter, are usually installed indoors or even in a basement. An existing cellular network technology can hardly provide a reliable communications service for devices at these locations, but an MTC base station needs to provide a stable connection service for such devices.

Very large quantity of connections: An MTC base station may serve a large quantity (exceeding tens of thousands or even hundreds of thousands) of internet of things terminal devices such as smart water/electricity meters, smart community devices, monitoring devices, vehicles, and wearable devices that are deployed on a large scale, far exceeding a currently supported quantity of mobile terminals. How to simultaneously provide a connection service to such a massive quantity of terminal devices without causing network congestion is a problem that needs to be resolved.

Low costs: Costs of an MTC terminal device needs to be lower than costs of an existing mobile terminal, and low costs are prerequisites for volume deployment of MTC devices.

Low power consumption: Because of diversified actual application and various deployment environments of MTC terminal devices, the MTC terminal devices are usually powered by using batteries. However, replacing batteries for such a massive quantity of devices consumes enormous manpower costs and time costs. Therefore, functional components of an MTC device usually need to have an extremely low power consumption level, so that the device can have a longer standby time, thereby reducing a quantity of times of battery replacement.

4. NB-IoT: Currently, the 3GPP standard is conducting research on how to fully leverage characteristics of a narrowband technology by designing a new air interface based on a cellular network to carry an IoT service. Such an IoT is referred to as an NB-IoT. Compared with those in a conventional cellular network, services and terminal devices in an NB-IoT system have the following characteristics:

(1) Low rate and long period of a service: In comparison with the conventional cellular network, an NB-IoT service generates smaller data packets and is usually latency-insensitive.

(2) Requirement for massive connections: An NB-IoT base station may serve a large quantity of internet of things terminal devices such as smart water/electricity meters, smart home devices, vehicles, and wearable devices that are deployed on a large scale. For example, the quantity may exceed tens of thousands.

(3) Requirement for low costs: Costs of terminal devices in the NB-IoT system need to be lower than those of existing terminal devices in a cellular network, to implement volume deployment of the terminal devices. The requirement for low costs necessitates very low implementation complexity of the terminal devices.

(4) Requirement for low power consumption: The NB-IoT system requires that the terminal devices have lower power consumption, to save battery power of the terminal devices and ensure ultra-long standby time of the terminal devices, thereby reducing manpower costs for replacing batteries.

To meet the foregoing requirements for low costs, deep coverage, and the like, the NB-IoT system has many designs. For example, the NB-IoT system does not use PUCCHs, to simplify the terminal devices and reduce costs. In addition, to implement deep coverage, a control channel (such as a narrowband physical downlink control channel (NPDCCH)) and a data channel (such as a narrowband physical downlink shared channel (NPDSCH) or a narrowband physical uplink shared channel (NPUSCH)) of the NB-IoT system use a manner of repeated sending, in which same content is sent repeatedly for hundreds of times, to improve a possibility that a terminal device with relatively poor coverage receives the content successfully.

5. Random access procedure: A random access procedure is a procedure that starts when a terminal device sends a random access preamble (preamble) to start to attempt to access a network, until a basic signaling connection with a network device is set up. Random access is a key step in a mobile communications system, and is also the last step by which the terminal device establishes a communications link with the network device. For example, the terminal device exchanges information with the network device in the random access procedure, to complete a subsequent operation such as calling, resource requesting, or data transmission. In addition, the terminal device may further implement uplink time synchronization with the system through random access.

Random access procedures may be classified into a contention-based random access procedure and a contention-free random access procedure. The embodiments of this application are mainly described by using the contention-based random access procedure as an example.

The contention-based random access procedure generally may include four steps:

Step 1: A terminal device sends a random access preamble to a network device, and the network device receives the random access preamble from the terminal device, where the random access preamble is also referred to as a first message (MSG1) in the random access procedure.

Step 2: The network device sends a random access response (RAR) message to the terminal device, and the terminal device receives the RAR message from the network device, where the RAR message is also referred to as a second message (MSG2) in the random access procedure.

Step 3: The terminal device sends, to the network device, uplink signaling for setting up a radio resource control (RRC) connection; and the network device receives the uplink signaling from the terminal device. The uplink signaling is also referred to as a third message (MSG3) in the random access procedure. The uplink signaling may usually include an RRC signaling part, a media access control control element (MAC CE), and the like. The RRC signaling may vary with scenarios, and is, for example, an RRC connection setup request, an RRC re-setup request, or an RRC recovery request.

Step 4: The network device sends an RRC connection setup message to the terminal device, and the terminal device receives the RRC connection setup message from the network device, where the RRC connection setup message is also referred to as a fourth message (MSG4) in the random access procedure.

6. A coverage level is also referred to as a coverage enhancement level. To ensure communication reliability and reduce a transmit power of a base station, UEs with different channel conditions need to be differentiated, to facilitate scheduling by the base station. Therefore, a concept of coverage level is introduced to the NB-IoT system. UEs at a same coverage level have similar channel transmission conditions. The base station uses similar scheduling parameters for the UEs, and the UEs also have similar control signaling overheads. For example, the NB-IoT system may define three coverage levels. A coverage level of UE that is relatively close to the base station is “common coverage”, and a number of repetitions is zero; a coverage level of UE that is relatively far away from the base station is “edge coverage”, and a number of repetitions is medium; and a coverage level of UE in a scenario such as a basement is “extended coverage”, and a number of repetitions may be up to several hundreds or even tens of hundreds. UE selects a coverage level based on a measured RSRP, and selects a proper quantity of transmissions based on the coverage level. This can reduce unnecessary repetitions, thereby reducing power overheads.

7. Currently, a base station configures an NPRACH resource separately for an anchor carrier and a non-anchor carrier. For example, the base station broadcasts NPRACH resource information of the anchor carrier on a system information block (SIB) 2-NB, and a downlink (DL) carrier corresponding to an uplink (UL) anchor carrier is definitely a downlink anchor carrier. The downlink anchor carrier may be an NB-IoT carrier that includes a narrowband physical broadcast channel (NPBCH), an NB-SIB1, a narrowband primary synchronization signal (NPSS), and a narrowband secondary synchronization signal (NSSS), that is, a carrier obtained by a terminal device through initial network search.

The base station delivers configuration information of a series of non-anchor carriers in a SIB22-NB, including configurations of a series of downlink non-anchor carriers and a series of uplink non-anchor carriers. It can be learned from the following configurations that an NPRACH resource is configured on each uplink non-anchor carrier based on a coverage level, and an indicator npdcch-Carrierindex-r14 may be configured for each NPRACH resource. The indicator is used to indicate a downlink carrier corresponding to the NPRACH resource; and the downlink carrier is used to send an NPDCCH that is retransmitted corresponding to an MSG2 and an MSG3, and send an NPDCCH and an NPDSCH NPDCCH that are retransmitted corresponding to an MSG4, where the MSG2, the MSG3, and MSG4 correspond to an MSG1 on the NPRACH resource. It can be further learned that a variable npdcch-NumRepetitions-RA-r14 is configured for each NPRACH resource, and is used to represent a maximum number of repetitions corresponding to common search space (common search space, CSS) of a downlink control channel of the downlink carrier, where the maximum number of repetitions is represented as Rmax. The downlink carrier is denoted as a first carrier, and is a downlink carrier on which the MSG2 in the random access procedure is located. A corresponding downlink carrier for sending the MSG2 is configured for each NPRACH resource corresponding to the MSG1. The downlink carrier is the first carrier. In other words, the first carrier may also be construed as a downlink carrier configured for a random access resource corresponding to the MSG1.

In addition, an Rmax parameter is also configured for the anchor carrier by using a SIB2. Rmax represents a maximum number of repetitions, of a downlink control channel carried on the anchor carrier, in common search space in which the downlink control channel is located; and therefore has a meaning similar to that of Rmax in the non-anchor carrier.

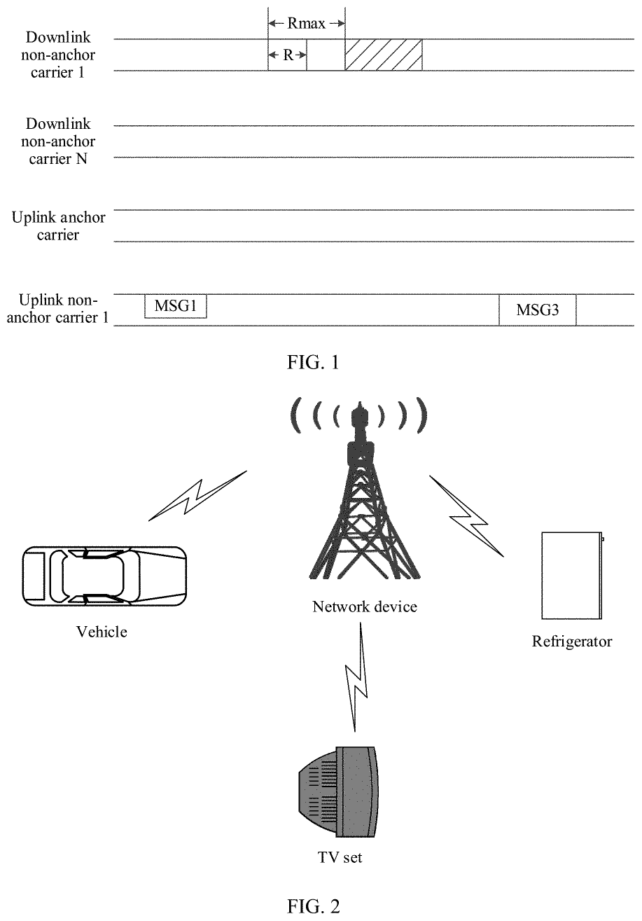

FIG. 1 is an example. In this example, a terminal device selects an NPRACH resource on an uplink non-anchor carrier 1 for sending an MSG1, and a SIB22 indicates that a downlink carrier corresponding to the uplink non-anchor carrier 1 is a downlink non-anchor carrier 1. Although the SIB22 indicates Rmax, during actual scheduling by a base station, R may be less than Rmax, in other words, actually R is used instead of Rmax, where R represents a number of repetitions of a downlink control channel that is used for scheduling for an MSG2 and that is actually sent in common search space in which a downlink control channel carried on a first carrier is located, that is, an actual quantity of retransmissions of the MSG2. Alternatively, this can be construed as follows: R represents a number of repetitions of the downlink control channel carried on the first carrier, the downlink control channel is used for scheduling for the MSG2, and the first carrier is a downlink carrier on which the MSG2 is located. As shown in FIG. 1, R is less than Rmax. In actual application, R is less than or equal to Rmax, and R is indicated in downlink control information (DCI) carried on the downlink control channel. The downlink control channel is, for example, an NPDCCH. In addition, a shaded part in FIG. 1 represents an NPDSCH.

8. Block error rate may be abbreviated as BLER, and may have other names. A BLER is a percentage of error blocks in all sent blocks. For example, the BLER may be equal to any one of {x×10e−1, x×10e−2, x×10e−3, x×10e−4, x×10e−5, x×10e−6, x×10e−7, x×10e−8, x×10e−9}, or may be equal to another value, where 10e−1=10⁻¹=0.1, and this formula is also applicable to other values of the BLER. x is a positive integer, for example, x=1 or 5, or x may be equal to another value. It can be understood that the BLER may be replaced by a correctness percentage, and the correctness percentage may be equal to any one of {1−x×1e−1, 1−x×1e−2, 1−x×1e−3, 1−x×1e−4, 1−x×1e−5, 1−x×1e−6, 1−x×1e−7, 1−x×1e−8, or 1−x×1e−9}.

9. A downlink control channel is used to carry control information. Channels included by the downlink control channel are not limited in this specification. For example, the downlink control channel includes a physical downlink control channel (PDCCH) or an NPDCCH, and may further include other downlink control channels that are used to transmit control information.

10. A power headroom (PH) is a difference between a maximum transmit power allowed by a terminal device and a currently evaluated transmit power of a physical uplink shared channel (PUSCH). The power headroom represents an amount of transmit power still available to the terminal device except the transmit power currently used for transmitting the PUSCH, and can be used as a reference for uplink resource allocation performed by a base station. However, algorithm design based on such a reference, or in other words, how the PH affects scheduling by the base station, is determined by an algorithm of each device vendor. For example, if the PH has a negative value, it represents that a current PUSCH transmit power has exceeded the maximum transmit power allowed by the terminal device, and less uplink resources may be allocated to the terminal device during next scheduling; and if the PH has a positive value, more uplink resources may be allocated subsequently.

In NB-IoT release 13 and release 14, a PH is carried in an MSG3 for transmission and occupies 2 bits.

When reporting the PH, the terminal device actually reports a power headroom level. Currently, there are four power headroom levels in total, and each power headroom level corresponds to a corresponding power headroom value. For the power headroom levels, refer to Table 1.

TABLE 1

| PH | Power headroom level (Power Headroom Level) |
|---|---|
| 0 | POWER_HEADROOM_0 |
| 1 | POWER_HEADROOM_1 |
| 2 | POWER_HEADROOM_2 |
| 3 | POWER_HEADROOM_3 |

In Table 1, PH 0 to PH 3 represent serial numbers of the four power headroom levels. For example, a power headroom level corresponding to PH 0 is POWER_HEADROOM_0. In addition, for correspondences between the power headroom levels and power headrooms, refer to Table 2.

TABLE 2

| Reported value | Measured value |
|---|---|
| (Reported value) | (Measured quantity value) (dB) |
| POWER_HEADROOM_0 | [−54] ≤ PH < 5 |
| POWER_HEADROOM_1 | 5 ≤ PH < 8 |
| POWER_HEADROOM_2 | 8 ≤ PH < 11 |
| POWER_HEADROOM_3 | PH ≥ 11 |

In Table 2, a reported value represents a power headroom level in Table 1, and a measured value represents a power headroom corresponding to a power headroom level. For example, a power headroom range corresponding to the power headroom level POWER_HEADROOM_0 is [−54] dB≤PH<5 dB. After determining a power headroom, the terminal device may select a power headroom level corresponding to the power headroom, and send the power headroom level to a network device. The network device can determine the power headroom of the terminal device based on the received power headroom level and Table 2.

There are only four power headroom levels in the foregoing, and a power headroom range corresponding to each power headroom level is relatively large. As a result, a granularity of reporting by the terminal device is relatively coarse, and the power headroom determined by the network device is inaccurate. Therefore, it is proposed in release 15 that a PH granularity be refined to introduce more power headroom levels. Power headrooms with more power headroom levels introduced into release 15 are subsequently referred to as enhancement PHs.

10. The terms “system” and “network” may be used interchangeably in the embodiments of this application. “A plurality of” means two or more. In view of this, in the embodiments of this application, “a plurality of” may also be construed as “at least two”. The term “and/or” describes an association relationship for describing associated objects and represents that three relationships may exist. For example, A and/or B may represent the following three cases: Only A exists, both A and B exist, and only B exists. In addition, the character “/” generally indicates an “or” relationship between the associated objects, unless otherwise stated.

In addition, unless otherwise stated, ordinal numbers such as “first” and “second” mentioned in the embodiments of this application are used to differentiate between a plurality of objects, but are not intended to limit an order, a time sequence, priorities, or importance of the plurality of objects.

While the foregoing describes some concepts in the embodiments of this application, the following describes the technical background of the embodiments of this application.

An NB-IoT system needs to support a very large coverage area, and a base station may use completely different scheduling policies for UEs in different communication environments. For example, UE located at a central location of a cell has relatively good wireless channel conditions; and the base station can set up a reliable communications link at a relatively low power, and can complete data transmission rapidly by using technical means such as a large transport code block, higher order modulation, and carrier binding. In contrast, UE located at an edge of a cell or in a basement has relatively poor wireless channel quality; and the base station may need to use relatively high power to maintain a link, and can complete data transmission only by using technologies such as a small code block, lower order modulation, a plurality of retransmissions, and a spread spectrum in a data transmission process.

To ensure communication reliability and save a transmit power of the base station, UEs with different channel conditions need to be differentiated, to facilitate scheduling by the base station. Therefore, a concept of coverage level is introduced into the NB-IoT system. UEs at a same coverage level have similar channel transmission conditions, the base station may use similar scheduling parameters for the users, and these UEs have similar control signaling overheads.

Currently, in an NB-IoT system of release (Rel)-13 or Rel-14, a coverage level is defined as follows: A base station provides, in system information, an RSRP decision threshold for differentiating between coverage levels. The RSRP decision threshold is mainly determined by the base station based on an uplink interference status. Provided that an RSRP is higher than the RSRP decision threshold, a preamble sequence of an MSG1 sent by a terminal device is detected by the base station in a preset probability.

An NB-IoT terminal device determines its coverage level according to the following process:

1. The terminal device obtains an RSRP value through measurement based on a narrowband reference signal (NRS) sent on a downlink NB-IoT carrier, where the RSRP value directly reflects a transmission loss of a wireless signal from a base station to the terminal device.

2. The terminal device compares the measured RSRP value with several RSRP decision thresholds, and determines its coverage level based on a result of the comparison. The RSRP decision thresholds are delivered by using a system message. In an NB-IoT system, currently, a maximum of two RSRP decision thresholds can be delivered. In the following example, two RSRP decision thresholds (an RSRP decision threshold 1 and an RSRP decision threshold 2) are delivered, where the RSRP decision threshold 2 is less than the RSRP decision threshold 1. If the RSRP value obtained through measurement by the terminal device is less than the RSRP decision threshold 2, the terminal device is at a coverage level 2 (corresponding to extended coverage). If the RSRP value obtained through measurement by the terminal device is greater than the RSRP decision threshold 2 and less than the RSRP decision threshold 1, the terminal device is at a coverage level 1 (corresponding to edge coverage). If the RSRP value obtained through measurement by the terminal device is greater than the RSRP decision threshold 1, the terminal device is at a coverage level 0 (corresponding to common coverage). The base station configures different narrowband physical random access channel (NPRACH) resources based on different coverage levels. Configuration information of an NPRACH resource includes information such as: a number of repetitions of an NPRACH format; configuration information of common search space of downlink control channels for scheduling for an MSG2, retransmission of an MSG3, and an MSG 4; and corresponding downlink carrier information.

3. The terminal device sends the MSG1 on an NPRACH resource corresponding to the determined coverage level. For different coverage levels, the terminal device selects a corresponding NPRACH resource for sending the MSG1, thereby ensuring performance of receiving an uplink NPRACH.

Currently, a base station sets an RSRP decision threshold based on an uplink interference status, mainly considering that performance of receiving an uplink NPRACH preamble should be ensured as far as possible. However, in actual network deployment, an interference level of uplink receiving of a base station is different from a downlink interference level of a terminal device. If an RSRP decision threshold is determined based on only an uplink interference status, the determined RSRP decision threshold may be inaccurate. For example, the base station determines the RSRP decision threshold based on the uplink interference status. For example, uplink interference may be relatively high, and the base station sets the RSRP decision threshold to a relatively large value. In this case, most terminal devices each may be located at a level with poor coverage and send a preamble for a plurality of times. However, downlink interference of some terminal devices may not be high, but these terminal devices each are located at a level with poor coverage. In this case, the base station also performs downlink scheduling for these terminal devices based on NPRACH resources corresponding to the coverage levels at which these terminal devices are located. As a result, a plurality of downlink retransmissions also need to be performed, causing waste of resources. Alternatively, uplink interference may be relatively low, and the base station sets the RSRP decision threshold to a relatively small value. In this case, most terminal devices each may be located at a level with good coverage and send a preamble for a relatively small quantity of times. However, downlink interference of some terminal devices may be relatively high, but these terminal devices each are located at a level with good coverage. In this case, the base station also performs downlink scheduling for these terminal devices based on NPRACH resources corresponding to the coverage levels at which these terminal devices are located. As a result, a quantity of downlink retransmissions is also relatively small, causing a failure in downlink receiving.

It can be learned that currently, a base station performs uplink and downlink scheduling for a terminal device based on only a coverage level at which the terminal device is located, so that a scheduling result is inaccurate.

In view of this, in technical solutions provided in the embodiments of this application, when performing scheduling for a terminal device, in addition to considering a coverage level at which the terminal device is located, a network device may further consider conditions such as downlink channel quality of the terminal device, so that the network device can perform scheduling for the terminal device in a more proper manner. This helps reduce waste of resources and improve resource utilization.

The foregoing describes the technical background of the embodiments of this application. FIG. 2 is a schematic diagram of an application scenario according to an embodiment of this application.

FIG. 2 shows a network device and a plurality of terminal devices. These terminal devices are terminal devices in an NB-IoT system, and include a refrigerator, a vehicle, a TV set, and the like. For example, the network device is an access network device such as a base station. The network device and the at least one terminal device shown in FIG. 2 may be configured to implement the technical solutions provided in the embodiments of this application.

With reference to the accompanying drawings, the following describes the technical solutions provided in the embodiments of this application. In all the examples for description below, the technical solutions provided in the embodiments of this application are applied to the application scenario shown in FIG. 2. Actual application is certainly not limited thereto.

An embodiment of this application provides an information sending and receiving method. In this method, a terminal device may send downlink channel quality information to a network device by using an MSG3 in a random access procedure. In this way, when determining an RSRP decision threshold, in addition to considering an uplink interference status, the network device may further consider a downlink channel quality status, so that an ultimately determined RSRP decision threshold is more accurate.

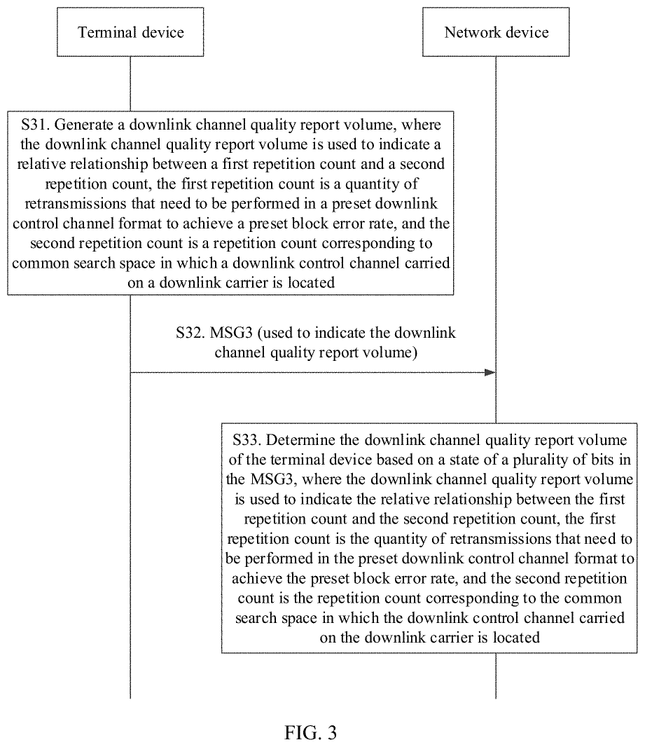

FIG. 3 is a flowchart of a first information sending and receiving method according to an embodiment of this application.

S31. A terminal device generates a downlink channel quality report volume, where the downlink channel quality report volume is used to indicate a relative relationship between a first number of repetitions and a second number of repetitions, the first number of repetitions is a quantity of retransmissions that need to be performed in a preset downlink control channel format to achieve a preset block error rate, and the second number of repetitions is a number of repetitions corresponding to common search space of a downlink control channel carried on a downlink carrier.

The second number of repetitions may also be construed as a number of repetitions, corresponding to the downlink control channel carried on the downlink carrier, in the common search space of the downlink control channel.

To generate the downlink channel quality report volume, the terminal device needs to obtain the first number of repetitions and the second number of repetitions. How the terminal device obtains the first number of repetitions is described first.

In this embodiment of this application, the terminal device may preset a mapping relationship between a signal to interference plus noise ratio (SINR) and a number of repetitions. For example, the mapping relationship includes several items, and each item represents that one SINR is associated with one number of repetitions. The mapping relationship may be obtained on the premise that a block error rate is ensured to reach a preset block error rate. One item in the mapping relationship is used for description. This can be construed as follows: One item represents a quantity of retransmissions that need to be performed in the preset downlink control channel format to achieve the preset block error rate, and the quantity corresponds to one SINR. For example, the terminal device may set the mapping relationship by using a simulation process under a preset condition. The preset block error rate is, for example, 1%, or may be another value.

For example, for the preset condition of the terminal device, refer to Table 3.

TABLE 3

| | Downlink channel quality | |
|---|---|---|
| Attribute (Attribute) | (Downlink channel quality) | |
| Downlink control information | Format N1 | Format |
| (DCI) format (format) | | N1 |
| Quantity of information bits | 23 bits | 23 bits |
| (Number of information bits) | | |
| System bandwidth | 200 kHz | 200 kHz |
| (System Bandwidth) | | |
| Antenna configuration | 2 × 1 | 2 × 1 |
| (Antenna configuration) | | |
| Aggregation level | 2 | 2 |
| (Aggregation level) | | |
| Discontinuous reception | Off (OFF) | OFF |
| (discontinuous reception, DRX) | | |

For example, a preset downlink control channel format is the format (format) N1 shown in Table 3.

The foregoing preset condition is merely an example, and this embodiment of this application does not exclude other preset conditions.

In this embodiment of this application, the terminal device may measure a downlink SINR, and query the preset mapping relationship after obtaining the SINR, to determine a number of repetitions corresponding to the SINR. The terminal device may obtain the first number of repetitions by performing measurement on different carriers.

In an optional manner, before sending an MSG1 in a random access procedure, that is, before the random access procedure starts, the terminal device may perform measurement on a downlink anchor carrier, to obtain the first number of repetitions. For example, before sending the MSG1 in the random access procedure, the terminal device measures an SINR of the downlink anchor carrier. For example, the SINR is referred to as a first SINR. In this case, the terminal device determines the first number of repetitions based on the SINR of the anchor carrier. Before sending the MSG1 in the random access procedure, the terminal device performs measurement on the downlink anchor carrier by using a reference signal. For example, the reference signal is an NRS. Alternatively, this can be construed as follows: Before sending the MSG1, the terminal device receives the NRS on the downlink anchor carrier, performs measurement based on the NRS to obtain the first SINR, and then can determine the first number of repetitions based on the SINR and the preset mapping relationship.

In another optional manner, after sending an MSG1 in a random access procedure, that is, after the random access procedure starts, the terminal device may perform measurement on a downlink carrier on which an MSG2 in the random access procedure is located, that is, a downlink carrier for sending the MSG2 in the random access procedure, to obtain the first number of repetitions. The terminal device sends the MSG1 by using a selected random access resource. In this embodiment of this application, the random access resource is, for example, an NPRACH resource. Before sending the MSG1, the terminal device first needs to select an NPRACH resource. For example, the terminal device selects, based on configurations in a SIB2 and a SIB22 in a preset probability, an uplink carrier for sending the MSG1. After selecting the uplink carrier, the terminal device can determine, based on the configuration in the SIB2 or the SIB22, a downlink carrier corresponding to the uplink carrier, that is, determine the downlink carrier on which the MSG2 is located. For example, after sending the MSG1 in the random access procedure, the terminal device measures an SINR of the downlink carrier on which the MSG2 is located. For example, the SINR is referred to as a second SINR. In this case, the terminal device can obtain the first number of repetitions based on the second SINR. After sending the MSG1 in the random access procedure, the terminal device performs measurement, by using a reference signal, on the downlink carrier on which the MSG2 is located. For example, the reference signal is an NRS. Alternatively, this can be construed as follows: Before sending the MSG1, the terminal device receives the NRS on a downlink anchor carrier, performs measurement based on the NRS to obtain the second SINR, and then can determine the first number of repetitions based on the SINR and the preset mapping relationship.

Whether the terminal device determines the first number of repetitions by performing measurement on the anchor carrier or determines the first number of repetitions by performing measurement on the downlink carrier on which the MSG2 is located may be stipulated by a protocol, or may be notified to the terminal device by a network device. This is not specifically limited.

While the foregoing describes how the terminal device obtains the first number of repetitions, the following describes how the terminal device obtains the second number of repetitions.

As described above, the second number of repetitions is the number of repetitions, corresponding to the downlink control channel carried on the downlink carrier, in the common search space in which the downlink control channel is located. The downlink carrier herein may vary. For example, the downlink carrier may be an anchor carrier, or the downlink carrier may be a first carrier. The first carrier is a downlink carrier configured for a random access resource corresponding to the MSG1 in the random access procedure. Alternatively, this can be construed as follows: The first carrier is a downlink carrier for sending the MSG2. During obtaining of the second number of repetitions, whether the downlink carrier is an anchor carrier or a downlink carrier on which the MSG2 is located may be stipulated by a protocol, or may be notified to the terminal device by the network device. This is not specifically limited. In this case, the second number of repetitions may vary with the downlink carrier.

If the downlink carrier is an anchor carrier, the second number of repetitions may be a maximum number of repetitions corresponding to common search space of a downlink control channel carried on the anchor carrier. This can be construed as follows: The second number of repetitions is a maximum number of repetitions, of the downlink control channel carried on the anchor carrier, in the common search space in which the downlink control channel is located. In other words, if the downlink carrier is an anchor carrier, the terminal device may determine the maximum number of repetitions, of the downlink control channel carried on the anchor carrier, in the common search space in which the downlink control channel is located, as the second number of repetitions, thereby obtaining the downlink channel quality report volume based on the first number of repetitions and the second number of repetitions.

The maximum number of repetitions, of the downlink control channel carried on the anchor carrier, in the common search space in which the downlink control channel is located is the Rmax parameter of the anchor carrier described above. The terminal device can obtain the Rmax parameter based on the configuration in the SIB2.

Alternatively, if the downlink carrier is a first carrier, the second number of repetitions may be a maximum number of repetitions corresponding to common search space of a downlink control channel carried on the first carrier. This can be construed as follows: The second number of repetitions is a maximum number of repetitions, of the downlink control channel carried on the first carrier, in the common search space in which the downlink control channel is located. In other words, if the downlink carrier is a first carrier, the terminal device may determine the maximum number of repetitions, of the downlink control channel carried on the first carrier, in the common search space in which the downlink control channel is located, as the second number of repetitions, thereby obtaining the downlink channel quality report volume based on the first number of repetitions and the second number of repetitions.

Depending on configuration information in an NPRACH resource, the first carrier may be an anchor carrier, or may be a non-anchor carrier. The maximum number of repetitions, of the downlink control channel carried on the first carrier, in the common search space in which the downlink control channel is located is the Rmax parameter of the first carrier described above. When the first carrier is an anchor carrier, the terminal device can obtain the Rmax parameter based on the SIB2. When the first carrier is a non-anchor carrier, the terminal device can obtain the Rmax parameter based on the SIB22.

Alternatively, if the downlink carrier is a first carrier, the second number of repetitions may be a number of repetitions of a downlink control channel carried on the first carrier, where the downlink control channel is used for scheduling for the MSG2. Alternatively, this can be construed as follows: The second number of repetitions is a number of repetitions of the downlink control channel that is used for scheduling for the MSG2 and that is actually sent in common search space in which the downlink control channel carried on the first carrier is located. In other words, if the downlink carrier is a first carrier, the terminal device can determine, as the second number of repetitions, the number of repetitions of the downlink control channel that is carried on the first carrier and that is used for scheduling for the MSG2, thereby obtaining the downlink channel quality report volume based on the first number of repetitions and the second number of repetitions.

Depending on configuration information in an NPRACH resource, the first carrier may be an anchor carrier, or may be a non-anchor carrier. The number of repetitions of the downlink control channel that is carried on the first carrier and that is used for scheduling for the MSG2 is the R parameter of the first carrier described above. For example, the terminal device may receive, from the network device on the first carrier, downlink control information (DCI) carried on the downlink control channel that is used for scheduling for the MSG2; and obtain the R parameter based on the DCI. After sending the MSG1, the terminal device listens to type2-NPDCCH common search space in a random access response (RAR) window of the downlink carrier configured for the random access resource corresponding to the MSG1. If detecting an NPDCCH that is masked by using a corresponding random access radio network temporary identity RA-RNTI (random access radio network temporary identity), the terminal device reads a corresponding NPDSCH; and learns, through parsing, whether an MSG2 on the NPDSCH includes a random access preamble identifier (RAPID) corresponding to the terminal device. If there is a corresponding RAPID, the terminal device processes a corresponding RAR, and determines a sending resource and a sending time for an MSG3. In this process, the terminal device can read downlink control information (DCI) that is carried on the NPDCCH and that is used to schedule the NPDSCH, to obtain an actual sending number of repetitions, that is, R, corresponding to the NPDCCH.

Whether the second number of repetitions is the number of repetitions of the downlink control channel that is carried on the first carrier and that is used for scheduling for the MSG2, or is the maximum number of repetitions, of the downlink control channel carried on the first carrier, in the common search space in which the downlink control channel is located may be stipulated by a protocol, or may be notified to the terminal device by the network device. This is not specifically limited.

While the foregoing describes how the terminal device obtains the first number of repetitions and the second number of repetitions, the following describes how the terminal device obtains the downlink channel quality report volume based on the first number of repetitions and the second number of repetitions.

In this embodiment of this application, the downlink channel quality report volume may be in different forms. For example, the downlink channel quality report volume may be a quantized value of a ratio between the first number of repetitions and the second number of repetitions. Alternatively, the downlink channel quality report volume may be a quantized value of a converted-to value, where the converted-to value is a value obtained by converting a ratio between the first number of repetitions and the second number of repetitions. This can be construed as follows: The relative relationship is used to represent the value obtained by converting the ratio between the first number of repetitions and the second number of repetitions, and the downlink channel quality report volume is the quantized value of the value obtained through conversion. Certainly, these two forms are merely examples. In this embodiment of this application, a form, a name, and the like of the downlink channel quality report volume are not limited, provided that the downlink channel quality report volume can indicate the relative relationship between the first number of repetitions and the second number of repetitions.

Because the downlink channel quality report volume may be in different forms, a manner in which the terminal device obtains the downlink channel quality report volume also varies. The manners are separately described below.

A. Manner 1

In manner 1, the downlink channel quality report volume is the quantized value of the ratio between the first number of repetitions and the second number of repetitions. This can be construed as follows: In manner 1, the relative relationship between the first number of repetitions and the second number of repetitions is used to represent the ratio between the first number of repetitions and the second number of repetitions, and the downlink channel quality report volume is the quantized value of the ratio.

In this case, the terminal device may obtain the downlink channel quality report volume in the following manner: The terminal device calculates the ratio between the first number of repetitions and the second number of repetitions; and the terminal device selects, from a preset value list, a quantized value corresponding to the ratio, where the quantized value is the downlink channel quality report volume. The quantized value that is in the value list and that corresponds to the ratio may be a quantized value that is in the value list and that has a smallest difference with the ratio. Alternatively, there may be another correspondence manner.

The first number of repetitions is represented as Q. For example, the second number of repetitions is Rmax of the downlink anchor carrier or Rmax of the downlink carrier on which the MSG2 is located. In this case, the terminal device may calculate a ratio between Q and Rmax, that is, Q/Rmax. After obtaining the ratio, the terminal device selects, from the preset value list, a quantized value having a smallest difference with the ratio. The quantized value is used to represent the downlink channel quality report volume, that is, represent downlink channel quality of the terminal device. The value list may be stipulated by a protocol, or may be preset by the network device and sent to the terminal device. This is not specifically limited. For example, the value list is

$$\{ \frac{1}{{2}^{K}} , \frac{2}{{2}^{K}} , \frac{3}{{2}^{K}} , … , \frac{{2}^{K} - 1}{{2}^{K}} \} ,$$

or for example, the value list is

$$\{ {2}^{( - {2}^{K} )} , {2}^{- ( {2}^{K} + 1 )} , … , {2}^{- 1} \} ,$$

where K is a quantity of a plurality of bits in the MSG3, or K is a quantity of bits in the MSG3 that are used to indicate the downlink channel quality report volume. For example, the plurality of bits include idle bits in the MSG3. However, it should be noted that because the plurality of bits have been used in this embodiment of this application, and the plurality of bits are assigned with an actual meaning, the plurality of bits can no longer be considered as “idle bits”. Therefore, the so-called “idle bits” herein represent only a meaning of these bits before they are used in this embodiment of this application.

Alternatively, the first number of repetitions is represented as Q. For example, the second number of repetitions is R of the downlink anchor carrier or R of the downlink carrier on which the MSG2 is located. In this case, the terminal device may calculate a ratio between Q and R, that is, Q/R. After obtaining the ratio, the terminal device selects, from the preset value list, a quantized value having a smallest difference with the ratio. The quantized value is used to represent the downlink channel quality report volume, that is, represent downlink channel quality of the terminal device. For descriptions of the value list, refer to the descriptions above.

B. Manner 2

In manner 2, the relative relationship between the first number of repetitions and the second number of repetitions is used to represent the value obtained by converting the ratio between the first number of repetitions and the second number of repetitions, and the downlink channel quality report volume is the quantized value of the value obtained through conversion.

In an optional manner, the terminal device may obtain the downlink channel quality report volume in the following manner: The terminal device calculates a first ratio, where the first ratio is a ratio between the first number of repetitions and a power factor, and the power factor is a ratio between an NRS power of the downlink carrier corresponding to the random access resource configured for the MSG1 in the random access procedure and an NRS power of the downlink anchor carrier. In this case, the terminal device calculates a second ratio, where the second ratio is a ratio between the first ratio and the second number of repetitions. The terminal device selects, from the preset value list, a quantized value corresponding to the second ratio, where the quantized value is the downlink channel quality report volume. The quantized value that is in the value list and that corresponds to the second ratio may be a quantized value that is in the value list and that has a smallest difference with the second ratio. Alternatively, there may be another correspondence manner.

The first number of repetitions is represented as Q. For example, the second number of repetitions is Rmax of the downlink anchor carrier or Rmax of the downlink carrier on which the MSG2 is located. The terminal device may calculate a ratio between Q and P, that is, Q/P, namely the first ratio, where P represents the power factor, and a value of P may be sent to the terminal device by the network device. After obtaining the first ratio, the terminal device may calculate the second ratio, that is, a ratio between the first ratio and Rmax, namely first ratio/Rmax, to obtain the second ratio. In other words, the terminal device calculates Q/P/Rmax, to obtain the second ratio. After obtaining the second ratio, the terminal device selects, from the preset value list, a quantized value having a smallest difference with the second ratio, where the quantized value is used to represent the downlink channel quality report volume, that is, represent downlink channel quality of the terminal device. For details about the value list, refer to related descriptions in manner 1. Details are not described herein again.

Alternatively, the first number of repetitions is represented as Q. For example, the second number of repetitions is R of the downlink carrier on which the MSG2 is located. The terminal device may calculate a ratio between Q and P, that is, Q/P, namely the first ratio, where P represents the power factor, and a value of P may be sent to the terminal device by the network device. After obtaining the first ratio, the terminal device may calculate the second ratio, that is, a ratio between the first ratio and R, namely first ratio/R, to obtain the second ratio. In other words, the terminal device calculates Q/P/R, to obtain the second ratio. After obtaining the second ratio, the terminal device selects, from the preset value list, a quantized value having a smallest difference with the second ratio, where the quantized value is used to represent the downlink channel quality report volume, that is, represent downlink channel quality of the terminal device. For details about the value list, refer to related descriptions in manner 1. Details are not described herein again.

In another optional manner, the terminal device may obtain the downlink channel quality report volume in the following manner: The terminal device calculates a first ratio, where the first ratio is a ratio between the first number of repetitions and the second number of repetitions. In this case, the terminal device calculates a second ratio, where the second ratio is a ratio between the first ratio and a power factor, and the power factor is a ratio between an NRS power of the downlink carrier corresponding to the random access resource configured for the MSG1 in the random access procedure and an NRS power of the downlink anchor carrier. The terminal device selects, from the preset value list, a quantized value corresponding to the second ratio, where the quantized value is the downlink channel quality report volume. The quantized value that is in the value list and that corresponds to the second ratio may be a quantized value that is in the value list and that has a smallest difference with the second ratio. Alternatively, there may be another correspondence manner.

The first number of repetitions is represented as Q. For example, the second number of repetitions is Rmax of the downlink anchor carrier or Rmax of the downlink carrier on which the MSG2 is located. The terminal device may calculate a ratio between the first number of repetitions and the second number of repetitions, that is, first number of repetitions/second number of repetitions (or represented as Q/Rmax), namely the first ratio. After obtaining the first ratio, the terminal device may calculate the second ratio, that is, a ratio between the first ratio and P, namely first ratio/P, to obtain the second ratio, where P represents the power factor, and a value of P may be sent to the terminal device by the network device. In other words, the terminal device calculates Q/Rmax/P, to obtain the second ratio. After obtaining the second ratio, the terminal device selects, from the preset value list, a quantized value having a smallest difference with the second ratio, where the quantized value is used to represent the downlink channel quality report volume, that is, represent downlink channel quality of the terminal device. For details about the value list, refer to related descriptions in manner 1. Details are not described herein again.

Alternatively, the first number of repetitions is represented as Q. For example, the second number of repetitions is R of the downlink carrier on which the MSG2 is located. The terminal device may calculate a ratio between Q and R, that is, Q/R, to obtain the first ratio. After obtaining the first ratio, the terminal device may calculate the second ratio, that is, a ratio between the first ratio and P, namely first ratio/P, to obtain the second ratio, where P represents the power factor, and a value of P may be sent to the terminal device by the network device. In other words, the terminal device calculates Q/R/P, to obtain the second ratio. After obtaining the second ratio, the terminal device selects, from the preset value list, a quantized value having a smallest difference with the second ratio, where the quantized value is used to represent the downlink channel quality report volume, that is, represent downlink channel quality of the terminal device. For details about the value list, refer to related descriptions in manner 1. Details are not described herein again.

The foregoing describes two different manners of calculating the downlink channel quality report volume by the terminal device. Manner 1 is applicable to a case in which the terminal device determines the first number of repetitions by using the downlink anchor carrier, and is also applicable to a case in which the terminal device determines the first number of repetitions by using the downlink carrier on which the MSG2 is located; while manner 2 is mainly applicable to a case in which the terminal device determines the first number of repetitions by using the downlink anchor carrier. Application of manner 2 can be construed as follows: The terminal device determines the first number of repetitions by performing measurement on the downlink anchor carrier, but a downlink control channel that carries information such as the MSG2 and that is actually received by the terminal device may not be the downlink control channel used by the terminal device to determine the first number of repetitions. Therefore, to reduce an error, a concept of power factor may be introduced, and power compensation is performed by using the power factor. Alternatively, this can be construed as being equivalent to the following: The first number of repetitions determined based on the downlink anchor carrier is converted into the first number of repetitions determined based on the downlink carrier on which the MSG2 is located, so that the finally determined first number of repetitions is more accurate and the downlink channel quality report volume obtained through calculation is also more accurate.

If the terminal device determines the first number of repetitions by using the downlink anchor carrier, whether the terminal device determines the downlink channel quality report volume in manner 1 or manner 2 may be stipulated by a protocol, or may be notified to the terminal device by the network device. This is not limited in this embodiment of this application.

In addition, in this embodiment of this application, after obtaining the downlink channel quality report volume, the terminal device may perform evaluation, to determine whether to report the downlink channel quality this time. For example, a preset range may be set in advance, or a channel quality threshold may be set in advance. If the downlink channel quality report volume obtained through calculation by the terminal device is within the preset range, or the downlink channel quality report volume obtained through calculation by the terminal device is greater than or equal to the preset channel quality threshold, the terminal device determines to indicate the downlink channel quality report volume to the network device by using the MSG3. Alternatively, if the downlink channel quality report volume obtained through calculation by the terminal device is outside the preset range, or the downlink channel quality report volume obtained through calculation by the terminal device is less than the preset channel quality threshold, the terminal device determines not to report the downlink channel quality report volume this time. This can be construed as follows: When the downlink channel quality report volume obtained through calculation is outside the preset range, or the downlink channel quality report volume obtained through calculation is less than the preset channel quality threshold, it indicates that the downlink channel quality of the terminal device is relatively good. In this case, little impact may be created even if the network device does not consider the downlink channel quality of the terminal device when determining an RSRP decision threshold. Therefore, in this case, the terminal device may choose not to report the downlink channel quality report volume. The preset range or the channel quality threshold may be stipulated by a protocol, or may be notified to the terminal device by the network device. This is not specifically limited.

Alternatively, if the downlink carrier corresponding to the random access resource used by the terminal device to send the MSG1 is a non-anchor carrier, the terminal device may also determine not to report the downlink channel quality this time.

S32. The terminal device sends the MSG3 to the network device in the random access procedure, where the MSG3 is used to indicate the downlink channel quality report volume; and the network device receives the MSG3.

After obtaining the downlink channel quality report volume through calculation, the terminal device may set a state of the plurality of bits in the MSG3 based on the downlink channel quality report volume. The plurality of bits in the MSG3 herein are bits, in the MSG3, that may be used to indicate the downlink channel quality report volume. One value of the plurality of bits represents one state, and one state may correspond to one downlink channel quality report volume. For example, a correspondence between values in the value list of quantized values and states of the plurality of bits may be set in advance. The correspondence may be stipulated by a protocol, or may be set by the network device and notified to the terminal device by the network device. This is not specifically limited. After learning of the correspondence between the values in the value list of quantized values and the states of the plurality of bits and obtaining the downlink channel quality report volume through calculation, the terminal device can set the state of the plurality of bits to a state corresponding to the downlink channel quality report volume obtained through calculation. In this case, the terminal device may send the MSG3 to the network device.

In this embodiment of this application, the plurality of bits in the MSG3 not only can indicate the downlink channel quality report volume, but also can be used to indicate that the terminal device does not support reporting of the downlink channel quality, or indicate that the terminal device does not report the downlink channel quality report volume this time. For example, the plurality of bits in the MSG3 are set to a state. For example, the state is a state in which all of the plurality of bits are set to 0, and if the state of the plurality of bits is an all-zeroed state, it indicates that the terminal device does not support reporting of the downlink channel quality, or it indicates that the terminal device does not report the downlink channel quality this time. Another state of the plurality of bits, that is, a non-all-0 state, can be used to indicate a corresponding downlink channel quality report volume. In this case, if the terminal device determines that the terminal device does not support reporting of the downlink channel quality or determines not to report the downlink channel quality this time, the terminal device may set the plurality of bits in the MSG3 to an all-0 state. However, if the terminal device obtains the downlink channel quality report volume through calculation, determines that the terminal device supports reporting of the downlink channel quality, and determines to report the downlink channel quality this time, the terminal device may set the plurality of bits to a corresponding state based on the downlink channel quality report volume. In this case, the state of the plurality of bits is a non-all-zeroed state.

Alternatively, the plurality of bits may be set to another relatively special state than the all-0 state that is relatively special. For example, the state is referred to as a preset state. A value of the plurality of bits that corresponds to the state is not limited in this embodiment of this application. For example, the state is a state in which all of the plurality of bits are set to 1, or a state in which the plurality of bits are set to another value. The state may be used to indicate that the terminal device does not report the downlink channel quality report volume this time, or the state may be used for future extended application.

The so-called future extended application means that the preset state is reserved in current design. The reserved state does not represent any function or indicator in the current design, but is used by a new terminal device when a new extension bit is introduced in the future, to instruct the network device to check the new extension bit, thereby supporting an extended function.

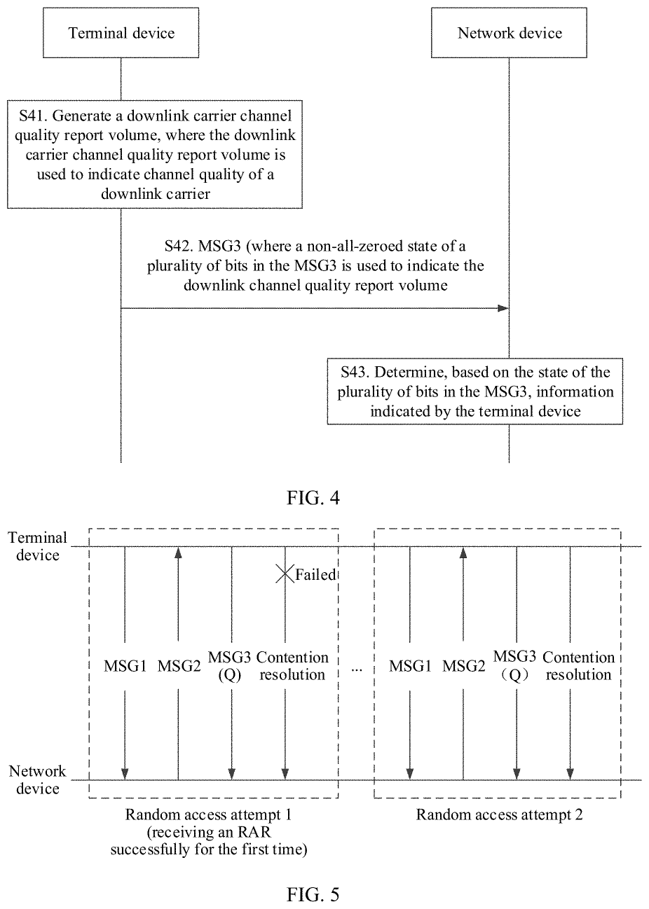

In addition, the MSG3 sent by the terminal device not only includes bits of a radio resource control (RRC) layer, but also includes bits of a media access control (MAC) layer. In this case, the bits used by the terminal device to indicate the downlink channel quality report volume may be the bits of the RRC layer, or may be the bits of the MAC layer. Related content will be detailed in the embodiment shown in FIG. 4 below, and therefore, is not described herein. For details, refer to related descriptions in the embodiment shown in FIG. 4.

S33. The network device determines the downlink channel quality report volume of the terminal device based on the state of the plurality of bits in the MSG3.

The network device also knows the correspondence between the values in the value list of quantized values and the states of the plurality of bits. After the network device receives the MSG3, if the state of the plurality of bits is a non-all-0 state, or if a preset state is set additionally, but the state of the plurality of bits is a non-preset state (that is, not the preset state), the network device may query the correspondence based on the state of the plurality of bits, to determine the downlink channel quality report volume sent by the terminal device, thereby learning of the downlink channel quality of the terminal device.

After obtaining the downlink channel quality report volume, the network device may determine, based on the downlink channel quality report volume, a number of repetitions of the NPDCCH used for scheduling for the terminal device and a number of repetitions and an MCS of the NPDSCH used for scheduling for the terminal device, so that the MCS and the number of repetitions during downlink scheduling are more adapted to the signal to interference plus noise ratio of the terminal device. In other words, when performing scheduling for the terminal device, in addition to considering a coverage level at which the terminal device is located, the network device may further consider a downlink channel quality status of the terminal device, so that scheduling for the terminal device by the network device is more proper and more adapted to an actual status of the terminal device.

For example, the network device determines the RSRP decision threshold based on an uplink interference status. For example, uplink interference may be relatively high, and the network device sets the RSRP decision threshold to a relatively large value. In this case, most terminal devices each may be at a level with poor coverage and send a preamble for a relatively large quantity of times. However, downlink interference of some terminal devices may not be high, and some of these terminal devices each indicate a downlink channel quality report volume to the network device. In this case, during subsequent scheduling for the terminal devices, in addition to considering the coverage levels at which the terminal devices are located, the network device may further consider downlink channel quality of the terminal devices. In this way, the network device does not perform scheduling repeatedly for an excessively large quantity of times for downlink transmission of the terminal device, thereby reducing waste of resources.

Alternatively, uplink interference may be relatively low, and the network device sets the RSRP decision threshold to a relatively small value. In this case, most terminal devices each may be located at a level with relatively poor coverage, and send a preamble repeatedly for a relatively small quantity of times. However, downlink interference of some terminal devices may be relatively high, and some of these terminal devices each indicate a downlink channel quality report volume to the network device. In this case, during subsequent scheduling for the terminal devices, in addition to considering the coverage levels at which the terminal devices are located, the network device may further consider downlink channel quality of the terminal devices. In this way, the network device may perform scheduling repeatedly for a relatively large quantity of times for downlink transmission of the terminal device, to ensure as far as possible that downlink transmission of these terminal devices can succeed, thereby improving a success rate of downlink transmission.

The network device may receive downlink channel quality report volumes sent by a plurality of terminal devices. In this case, the network device determines, based on the downlink channel quality report volume sent by each terminal device, an MSG4 in a random access procedure, a number of repetitions of a downlink NPDCCH after the MSG4 is received, and a combination of an MCS and a number of repetitions of an NPDSCH after the MSG4 is received. The foregoing only uses one terminal device as an example. If a plurality of terminal devices each need to send a downlink channel quality report volume to the network device, a process in which each of the plurality of terminal devices generates a downlink channel quality report volume and a manner of sending the downlink channel quality report volume are similar to those described above. For details, refer to related descriptions above.

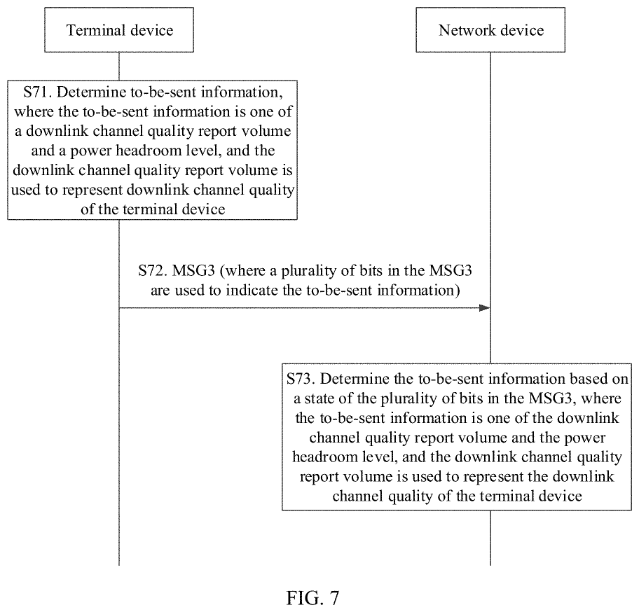

In addition, considering that the MSG3 not only may be used to indicate the downlink channel quality report volume, but also may be used to indicate a power headroom level of an enhanced PH, if a quantity of the idle bits in the MSG3 is less than a sum of a quantity of bits used to indicate the downlink channel quality report volume and a quantity of bits used to indicate the power headroom level of the enhanced PH, a mechanism for determining how the MSG3 indicates the downlink channel quality report volume and the power headroom level of the enhanced PH is needed. Related content will be detailed in the embodiment shown in FIG. 7, and therefore, is not described herein. For details, refer to related descriptions in the embodiment shown in FIG. 7 below.

In this embodiment of this application, the downlink channel quality report volume can be obtained and indicated to the network device, so that the network device can learn of downlink receiving performance of the terminal device based on the downlink channel quality report volume indicated by the MSG3, thereby determining the number of repetitions that is of the NPDCCH and that corresponds to the downlink receiving performance of the terminal device, or determining the MCS and the number of repetitions that are of the NPDSCH and that correspond to the downlink receiving performance of the terminal device. The downlink receiving performance of the terminal device is related to a downlink signal to interference plus noise ratio of the terminal device and a receiving capability of a downlink receiver of the terminal device.

In addition, in this embodiment of this application, the downlink channel quality report volume is used to indicate the relative relationship between the first number of repetitions and the second number of repetitions. This is equivalent that downlink channel quality information of the terminal device is represented by a quantized value. Compared with direct sending of the first number of repetitions, sending of the quantized value requires far fewer bits. This helps save transmission resources. In addition, a quantity of bits that are in the MSG3 and that can be used to indicate the downlink channel quality report volume is also limited. According to the technical solution in this embodiment of this application, an objective of indicating the downlink channel quality report volume by using the limited bits in the MSG3 can also be achieved, thereby improving resource utilization.

As described above, the terminal device can indicate the downlink channel quality report volume to the network device, so that the network device can learn of the downlink channel quality of the terminal device. The terminal device indicates the downlink channel quality report volume to the network device by using the MSG3. The following uses another embodiment to describe how the terminal device indicates the downlink channel quality to the network device by using the MSG3.

How to obtain the downlink channel quality information on the premise that the downlink channel quality information is sent by using the MSG3 is a problem that needs to be resolved. Currently, an NB-IoT system supports sending of an MSG1 on an anchor carrier or a non-anchor carrier. Correspondingly, a downlink carrier for sending an MSG2 that corresponds to the MSG1 may be an anchor carrier or a non-anchor carrier. However, on the other hand, currently, an NB-IoT terminal device performs measurement only on an anchor carrier. Therefore, when the downlink carrier for sending the MSG2 is a non-anchor carrier, the downlink channel quality information reported by the MSG3 cannot reflect an actual channel quality level of scheduling for an MSG4 of the terminal device by the network device and an actual channel quality level of a downlink carrier on which another downlink NPDSCH is located. Therefore, there is a possibility that the downlink channel quality information in the MSG3 does not correspond to or match actual downlink channel quality of a downlink carrier used by the terminal device.

To resolve this technical problem, FIG. 4 describes a second information sending and receiving method according to an embodiment of this application.

S41. A terminal device generates a downlink carrier channel quality report volume, where the downlink carrier channel quality report volume is used to represent channel quality of a downlink carrier.

In this embodiment of this application, the terminal device may obtain the downlink carrier channel quality report volume by performing measurement on the downlink carrier. This can be construed as follows: The terminal device performs measurement on the downlink carrier, to obtain a quantity of retransmissions that need to be performed in a preset downlink control channel format to achieve a preset block error rate, where the downlink channel quality report volume is determined based on the quantity of retransmissions. For example, the quantity of retransmissions is referred to as a first quantity of retransmissions.

The downlink carrier may vary. For example, the downlink carrier may be a downlink anchor carrier, or the downlink carrier may be a carrier for sending an MSG2 in a random access procedure. A manner in which the terminal device obtains a first number of repetitions varies with the downlink carrier. The following describes how the terminal device obtains the first number of repetitions.

In this embodiment of this application, the terminal device may preset a mapping relationship between an SINR and a number of repetitions. For example, the mapping relationship includes several items, and each item represents that one SINR is associated with one number of repetitions. The mapping relationship may be obtained on the premise that a block error rate is guaranteed to reach a preset block error rate. One item in the mapping relationship is used for description. This can be construed as follows: One item represents a quantity of retransmissions that need to be performed in the preset downlink control channel format to achieve the preset block error rate, and the quantity corresponds to one SINR. For example, the terminal device may set the mapping relationship by using a simulation process under a preset condition. The preset block error rate is, for example, 1%, or may be another value.

For example, for the preset condition of the terminal device, refer to Table 3 in the embodiment shown in FIG. 3. Certainly, the preset condition is merely an example, and this embodiment of this application does not exclude other preset conditions.

In this embodiment of this application, the terminal device may measure a downlink SINR, and query the preset mapping relationship after obtaining the SINR, to determine a number of repetitions corresponding to the SINR, that is, the first number of repetitions. The terminal device may obtain the first number of repetitions by performing measurement on different downlink carriers.

In an optional manner, the downlink carrier is a downlink anchor carrier. In this case, before sending an MSG1 in the random access procedure, that is, before the random access procedure starts, the terminal device may perform measurement on the downlink anchor carrier, to obtain the first number of repetitions. For example, before sending the MSG1 in the random access procedure, the terminal device measures an SINR of the downlink anchor carrier. For example, the SINR is referred to as a first SINR. In this case, the terminal device determines the first number of repetitions based on the SINR of the anchor carrier. Before sending the MSG1 in the random access procedure, the terminal device performs measurement on the downlink anchor carrier by using a reference signal. For example, the reference signal is an NRS. Alternatively, this can be construed as follows: Before sending the MSG1, the terminal device receives the NRS on the downlink anchor carrier, performs measurement based on the NRS to obtain the first SINR, and then can determine the first number of repetitions based on the first SINR and the preset mapping relationship.

In another optional manner, the downlink carrier is a carrier for sending the MSG2 in the random access procedure. In this case, after sending the MSG1 in the random access procedure, that is, after the random access procedure starts, the terminal device performs measurement on the downlink carrier on which the MSG2 in the random access procedure is located, that is, a downlink carrier for sending the MSG2 in the random access procedure, to obtain the first number of repetitions. The terminal device sends the MSG1 by using a selected random access resource. In this embodiment of this application, the random access resource is, for example, an NPRACH resource. Before sending the MSG1, the terminal device first needs to select an NPRACH resource. For example, the terminal device selects, based on configurations in a SIB2 and a SIB22 in a preset probability, an uplink carrier for sending the MSG1. After selecting the uplink carrier, the terminal device can determine, based on the configuration in the SIB2 or the SIB22, a downlink carrier corresponding to the uplink carrier, that is, determine the downlink carrier on which the MSG2 is located. For example, after sending the MSG1 in the random access procedure, the terminal device measures an SINR of the downlink carrier on which the MSG2 is located. For example, the SINR is referred to as a second SINR. In this case, the terminal device can obtain the first number of repetitions based on the second SINR. After sending the MSG1 in the random access procedure, the terminal device performs measurement, by using a reference signal, on the downlink carrier on which the MSG2 is located. For example, the reference signal is an NRS. Alternatively, this can be construed as follows: Before sending the MSG1, the terminal device receives the NRS on a downlink anchor carrier, performs measurement based on the NRS to obtain the second SINR, and then can determine the first number of repetitions based on the second SINR and the preset mapping relationship.

Whether the terminal device determines the first number of repetitions by performing measurement on the anchor carrier or determines the first number of repetitions by performing measurement on the downlink carrier on which the MSG2 is located may be stipulated by a protocol, or may be notified to the terminal device by a network device. This is not specifically limited.

In this embodiment of this application, a method used by the terminal device to generate the downlink carrier channel quality report volume is not limited, or in other words, a form of the downlink carrier channel quality report volume is not limited. For example, the terminal device may directly determine the first number of repetitions as the downlink carrier channel quality report volume. Alternatively, the terminal device may generate the downlink carrier channel quality report volume in the manner described in the embodiment shown in FIG. 3. In other words, in addition the first number of repetitions, the terminal device further obtains the second number of repetitions described in the embodiment shown in FIG. 3. For a manner of obtaining the second number of repetitions, refer to the manner described in the embodiment shown in FIG. 3. The terminal device obtains the downlink carrier channel quality report volume based on the first number of repetitions and the second number of repetitions. For a manner of obtaining the downlink carrier channel quality report volume, also refer to the manner of obtaining the downlink channel quality report volume by the terminal device described in the embodiment shown in FIG. 3. Alternatively, the terminal device may generate the downlink carrier channel quality report volume in another manner, provided that the downlink carrier channel quality report volume can reflect the channel quality of the downlink carrier.

S42. The terminal device sends an MSG3 to the network device in the random access procedure, and the network device receives the MSG3.

The terminal device generates the MSG3, and sends the MSG3 to the network device. A non-all-0 state of a plurality of bits in the MSG3 is used to indicate the downlink carrier channel quality report volume.

S43. The network device determines, based on the state of the plurality of bits in the MSG3, information indicated by the terminal device, where when the plurality of bits in the MSG3 are in a non-all-0 state, the network device determines the downlink carrier channel quality report volume.

Certainly, the terminal device first sends the MSG1 to the network device, and the network device receives the MSG1; the network device sends the MSG2 to the terminal device, and the terminal device receives the MSG2; and then the terminal device sends the MSG3 to the network device.

The terminal device indicates the downlink carrier channel quality report volume to the network device by using the plurality of bits in the MSG3. For example, one value of the plurality of bits is considered as one state of the plurality of bits. In this case, different states of the plurality of bits may correspond to different downlink carrier channel quality report volumes. For example, the terminal device may obtain N channel quality thresholds in advance, determine N+1 channel quality intervals based on the N channel quality thresholds, and determine that the N+1 channel quality intervals are in a one-to-one correspondence with N+1 states of the plurality of bits, where all the N+1 states are non-all-0 states. Each channel quality interval includes at least one downlink carrier channel quality report volume. Certainly, a form of the downlink carrier channel quality report volume included in the channel quality interval varies with a form of the downlink carrier channel quality report volume. In this case, after obtaining the downlink carrier channel quality report volume, the terminal device may determine a channel quality interval, of the N+1 channel quality intervals, into which the downlink carrier channel quality report volume falls; and after determining the channel quality interval, may set the state of the plurality of bits to a state corresponding to the channel quality interval into which the downlink carrier channel quality report volume falls. For example, the terminal device determines that the downlink carrier channel quality report volume falls into a first channel quality interval of the N+1 channel quality intervals, and a state of the plurality of bits that corresponds to the first channel quality interval is a first state. In this case, the terminal device sets the state of the plurality of bits in the MSG3 to the first state, and then sends the MSG3 to the network device. After receiving the MSG3, the network device determines that the state of the plurality of bits is the first state. In this case, the network device can determine that the downlink carrier channel quality report volume of the terminal device falls into the first channel quality interval, that is, determine the downlink carrier channel quality report volume of the terminal device.

The N channel quality thresholds may be configured by the network device. In this case, a manner in which the terminal device obtains the N channel quality thresholds is that: the terminal device receives the N channel quality thresholds configured by the network device. Alternatively, the N channel quality thresholds may be stipulated by a protocol. This is not specifically limited. In addition, accuracy of the channel quality that is of the downlink carrier and that is determined by the network device improves as a value of N increases.

For another example, one value of the plurality of bits is considered as one state of the plurality of bits. In this case, different states of the plurality of bits may correspond to different downlink carrier channel quality report volumes. For example, the terminal device may obtain N channel quality thresholds in advance, and determine N channel quality intervals based on the N channel quality thresholds, where the X^{th} (X=1, 2, 3, . . . , N) channel quality interval corresponds to an interval that is less than or equal to the X^{th} channel quality threshold and greater than or equal to the (X−1)^{th} channel quality threshold. The terminal device may determine that the N channel quality intervals are in a one-to-one correspondence with N states of the plurality of bits, and all the N states are non-all-0 states. Each channel quality interval includes at least one downlink carrier channel quality report volume. Certainly, a form of the downlink carrier channel quality report volume included in the channel quality interval varies with a form of the downlink carrier channel quality report volume. In this case, after obtaining the downlink carrier channel quality report volume, the terminal device may determine a channel quality interval, of the N channel quality intervals, into which the downlink carrier channel quality report volume falls; and after determining the channel quality interval, may set the state of the plurality of bits to a state corresponding to the channel quality interval into which the downlink carrier channel quality report volume falls. For example, the terminal device determines that the downlink carrier channel quality report volume falls into a first channel quality interval of the N channel quality intervals, and a state of the plurality of bits that corresponds to the first channel quality interval is a first state. In this case, the terminal device sets the state of the plurality of bits in the MSG3 to the first state, and then sends the MSG3 to the network device. After receiving the MSG3, the network device determines that the state of the plurality of bits is the first state. In this case, the network device can determine that the downlink carrier channel quality report volume of the terminal device falls into the first channel quality interval, that is, determine the downlink carrier channel quality report volume of the terminal device.

The N channel quality thresholds may be configured by the network device. In this case, a manner in which the terminal device obtains the N channel quality thresholds is that: the terminal device receives the N channel quality thresholds configured by the network device. Alternatively, the N channel quality thresholds may be stipulated by a protocol. This is not specifically limited. In addition, accuracy of the channel quality that is of the downlink carrier and that is determined by the network device improves as a value of N increases.

In an example, the N thresholds in this embodiment are Rmax values that correspond to one to three coverage levels and that are broadcast by a network device. For example, if a base station has configured three coverage levels, Rmax values corresponding to the three coverage levels are used as three thresholds, and three corresponding channel quality intervals are respectively (0−R_{max,CE0}), (R_{max,CE0}, R_{max,CE1}), and (R_{max,CE1}, R_{max,CE2}), where CE0, CE1, and CE2 represent the three coverage levels in ascending order in terms of quality. In this example, the plurality of bits in the MSG3 are 2 bits, where an all-zeroed state is ‘00’, and the three non-all-zeroed states respectively correspond to the three channel quality intervals.

In another example, one value of the plurality of bits is considered as one state of the plurality of bits. In this case, different states of the plurality of bits may correspond to different coverage levels. For example, if a base station has configured three coverage levels, Rmax values corresponding to the three coverage levels are respectively R_{max,CE0}, R_{max,CE1}, and R_{max,CE2}, where CE0, CE1, and CE2 represent the three coverage levels in ascending order in terms of quality. In this embodiment, the plurality of bits in the MSG3 are 2 bits, where an all-zeroed state is ‘00’, and the three non-all-zeroed states respectively represent that downlink channel report volumes are R_{max,CE0}, R_{max,CE1}, and R_{max,CE2}; or (0−R_{max,CE0}), (R_{max,CE0}, R_{max,CE1}), and (R_{max,CE1}, R_{max,CE2}).

In the foregoing manner of this embodiment, when a carrier for sending the MSG1 is an anchor carrier, a downlink carrier for sending the MSG2 is also a downlink anchor carrier. In this case, the terminal device performs measurement on the anchor carrier, to obtain channel quality information of the anchor carriers, for determining an MSG4 for which scheduling is to be performed subsequently on the anchor carrier and determining number of repetitions and MCSs for subsequent transmission of a PDCCH and a PDSCH. This resolves a problem that reported channel quality information does not match channel quality of the downlink carrier of the MSG4 and channel quality of a downlink carrier on which the PDCCH and the PDSCH are subsequently located.

In the foregoing manner of this embodiment, when a carrier for sending the MSG1 is a non-anchor carrier, a downlink carrier for sending the MSG2 may be a downlink anchor carrier or may be a downlink non-anchor carrier. In this case, after sending the MSG1, the terminal performs measurement on the downlink carrier for sending the MSG2 to obtain downlink channel quality, and reports the downlink channel quality by using the MSG3, for determining an MSG4 for which scheduling is to be performed subsequently on an anchor carrier and determining number of repetitions and MCSs for subsequent transmission of a PDCCH and a PDSCH. This resolves a problem that reported channel quality information does not match channel quality of the downlink carrier of the MSG4 and channel quality of a downlink carrier on which the PDCCH and the PDSCH are subsequently located.

In this embodiment of this application, the plurality of bits in the MSG3 not only can indicate the downlink carrier channel quality report volume, but also can be used to indicate that the terminal device does not support reporting of the channel quality of the downlink carrier, or indicate that the terminal device does not report the downlink carrier channel quality report volume this time. For example, the plurality of bits in the MSG3 are set to a state. For example, the state is a state in which all of the plurality of bits are set to 0 (which is referred to as an all-0 state), in other words, the all-0 state of the plurality of bits is reserved, and if the state of the plurality of bits is an all-zeroed state, it indicates that the terminal device does not support reporting of the channel quality of the downlink carrier, or it indicates that the terminal device does not report the channel quality of the downlink carrier this time. However, another state of the plurality of bits, that is, a non-all-0 state, can be used to indicate a corresponding downlink carrier channel quality report volume. In this case, if the terminal device determines that the terminal device does not support reporting of the channel quality of the downlink carrier or determines not to report the channel quality of the downlink carrier this time, the terminal device may set the plurality of bits in the MSG3 to an all-0 state. However, if the terminal device obtains the downlink carrier channel quality report volume through calculation, determines that the terminal device supports reporting of the channel quality of the downlink carrier, and determines to report the channel quality of the downlink carrier this time, the terminal device may set the plurality of bits to a corresponding state based on the downlink carrier channel quality report volume. In this case, if the terminal device needs to indicate the downlink carrier channel quality report volume to the network device, the state of the plurality of bits is a non-all-0 state.

Alternatively, the plurality of bits may be set to another relatively special state than the all-0 state that is relatively special. For example, the state is referred to as a preset state, and the preset state is a non-all-0 state. A value of the plurality of bits that corresponds to the preset state, that is, a non-all-0 state of the plurality of bits that the preset state represents, is not limited in this embodiment of this application. For example, the preset state is a state in which all of the plurality of bits are set to 1, or a state in which the plurality of bits are set to another value. The preset state may be used to indicate that the terminal device does not report the downlink carrier channel quality report volume this time. Alternatively, the preset state may be used for future extended application or represent that the measured downlink carrier channel quality report volume is outside a preset range. In this case, if the terminal device needs to indicate the downlink carrier channel quality report volume to the network device, the state of the plurality of bits is a non-all-0 state, and is not the preset state. In this case, all other states of the plurality of bits than the preset state may be considered as non-preset states. The preset state can be considered as a state, other than the all-0 state, that is unavailable to the downlink carrier channel quality report volume; and a non-preset and non-all-0 state can be considered as a state available to the downlink carrier channel quality report volume.

It should be noted that if the terminal device does not support reporting of a downlink carrier channel quality report volume, S41 is an unnecessary step for the terminal device. In other words, the terminal device directly generates the MSG3, and sets the state of the plurality of bits in the MSG to the all-0 state or the preset state. From this perspective, S41 is an optional step. In addition, according to the descriptions, the plurality of bits in the MSG3 sent by the terminal device and received by the network device in S42 may be in a non-all-0 and non-preset state, or may be in the all-0 state or the preset state. In other words, the MSG3 may be used to indicate the downlink channel quality report volume, or may be used to indicate that the terminal device does not support reporting of the channel quality of the downlink carrier, indicate that the terminal device does not report the channel quality of the downlink carrier this time, or indicate other extended application.

However, if the terminal device supports reporting of a downlink carrier channel quality report volume, the terminal device may still perform S41. After performing S41, the terminal device may perform evaluation based on the obtained downlink carrier channel quality report volume, to determine whether to report the downlink carrier channel quality report volume this time. If determining to report the downlink carrier channel quality report volume this time, the terminal device may set, according to the manner described above, the state of the plurality of bits in the MSG3 to a state corresponding to the downlink carrier channel quality report volume, to indicate the downlink channel quality report volume. If the terminal device determines not to report the downlink carrier channel quality report volume this time, the terminal device may set the state of the plurality of bits in the MSG to the all-0 state or the preset state. After the network device receives the MSG3, if determining that the state of the plurality of bits in the MSG3 is a non-all-0 and non-preset state, the network device may determine, based on the state of the plurality of bits, the downlink carrier channel quality report volume indicated by the terminal device. If the network device determines the state of the plurality of bits in the MSG3 is the all-0 state or the preset state, the network device may determine that the terminal device does not support reporting of the downlink carrier channel quality report volume or that the terminal device does not report the downlink carrier channel quality report volume this time, or determine another extended manner.

Setting of the all-0 state can be construed as follows: If a preset condition is met, the terminal device sets the state of the plurality of bits to the all-0 state. For example, in a preset condition, when the downlink carrier is a non-anchor carrier, the state of the plurality of bits in the MSG3 is set to the all-zeroed state. For example, in another preset condition, the terminal device generates the downlink carrier channel quality report volume before generating the MSG3; and if determining that the downlink carrier channel quality report volume is outside a preset range, or determining that the downlink carrier channel quality report volume is less than a preset channel quality threshold, sets the state of the plurality of bits in the MSG3 to the all-zeroed state. Simply put, the all-0 state is used to indicate that the terminal device does not support reporting of the channel quality of the downlink carrier, or used to indicate that the terminal device does not report the channel quality of the downlink carrier this time. If determining that the state of the plurality of bits is the all-0 state, the network device can determine that the terminal device does not support reporting of the channel quality of the downlink carrier, or determine that the terminal device does not report the channel quality of the downlink carrier this time.

Under some preset conditions, the terminal device sets all of the plurality of bits in the MSG3 to 0. Under these preset conditions, the terminal device does not need to occupy a non-all-0 state of the plurality of bits in the MSG3. In this case, the terminal device may also perform reporting by using the all-0 state. This further saves a non-all-0 state, thereby achieving a finer reporting granularity of the downlink carrier channel quality report volume.

The terminal device may not support reporting of the channel quality of the downlink carrier because of a version or the like. However, concerning whether to report the channel quality of the downlink carrier this time, the terminal device may perform corresponding evaluation. For example, the terminal device may perform evaluation after obtaining the downlink carrier channel quality report volume, to determine whether to report the channel quality of the downlink carrier this time. For example, a preset range may be set in advance, or a channel quality threshold may be set in advance. If the downlink carrier channel quality report volume obtained by the terminal device is within the preset range, or the downlink carrier channel quality report volume obtained by the terminal device is greater than or equal to the preset channel quality threshold, the terminal device determines to indicate the downlink carrier channel quality report volume to the network device by using the MSG3. Alternatively, if the downlink carrier channel quality report volume obtained by the terminal device is outside the preset range, or the downlink carrier channel quality report volume obtained by the terminal device is less than the preset channel quality threshold, the terminal device determines not to report the downlink carrier channel quality report volume this time. This can be construed as follows: When the obtained downlink carrier channel quality report volume is outside the preset range, or the obtained downlink carrier channel quality report volume is less than the preset channel quality threshold, it indicates that downlink channel quality of the terminal device is relatively good. In this case, little impact may be created even if the network device does not consider the channel quality of the downlink carrier of the terminal device when determining an RSRP decision threshold. Therefore, in this case, the terminal device may choose not to report the downlink carrier channel quality report volume. In this case, the terminal device sets the plurality of bits in the MSG3 to the all-0 state. The preset range or the channel quality threshold may be stipulated by a protocol, or may be notified to the terminal device by the network device. This is not specifically limited.

Alternatively, if a downlink carrier corresponding to a random access resource used by the terminal device to send the MSG1 is a non-anchor carrier, that is, the downlink carrier for sending the MSG2 is a non-anchor carrier, the terminal device may also determine not to report the channel quality of the downlink carrier this time. In this case, the terminal device sets the plurality of bits in the MSG3 to the all-0 state.

It can be learned from the foregoing descriptions that if the terminal device determines not to report the channel quality of the downlink carrier this time, the terminal device may set the state of the plurality of bits in the MSG3 to the all-0 state. In other words, the plurality of bits in the all-0 state may indicate that the terminal device does not support reporting of the downlink channel quality, or indicate that the terminal device does not report the downlink channel quality this time.

It can be learned from the foregoing descriptions that if the terminal device determines that the downlink carrier channel quality report volume is outside the preset range, or is less than the configured channel quality threshold, the terminal device may set the state of the plurality of bits in the MSG3 to the non-all-0 preset state. In other words, the plurality of bits in the preset state can be considered as indicating that the downlink channel quality reported by the terminal device this time is outside the preset range or less than the channel quality threshold.

The MSG3 sent by the terminal device not only includes bits of a radio resource control (radio resource control, RRC) layer, but also includes bits of a media access control (media access control, MAC) layer. In this case, the bits used by the terminal device to indicate the downlink channel quality report volume may be the bits of the RRC layer or may be the bits of the MAC layer. The two cases are separately described below.

1. The plurality of bits used to indicate the downlink carrier channel quality report volume are the bits of the RRC layer.

The terminal device indicates the downlink carrier channel quality report volume by using the bits of the RRC layer in the MSG3. A value of the bits of the RRC layer in the MSG3 usually has been determined before the random access procedure starts. If the terminal device indicates the downlink carrier channel quality report volume by using the bits of the RRC layer in the MSG3, during obtaining of the downlink carrier channel quality report volume, the terminal device can obtain the downlink carrier channel quality report volume only by performing measurement on the downlink anchor carrier. Therefore, a process of measuring and obtaining the downlink carrier channel quality report volume needs to be performed before the random access procedure, and a process of measuring the downlink anchor carrier needs to be performed before the MSG1 is sent, so as to meet a requirement of indicating the downlink carrier channel quality report volume by using the bits of the RRC layer in the MSG3 can be met.

Moreover, the value of the bits of the RRC layer in the MSG3 cannot be modified in the entire random access procedure. Therefore, if the terminal device indicates the downlink carrier channel quality report volume by using the bits of the RRC layer in the MSG3, in the entire random access procedure, during MSG3 retransmission, or during MSG3 resending after MSG1 retransmission, modification of the downlink carrier channel quality report volume is not allowed. In other words, the entire random access procedure may last for a relatively short time, or may last for a relatively long time. Regardless of how long the random access procedure lasts, the downlink carrier channel quality report volume indicated by the terminal device by using the MSG3 is not changed in the entire random access procedure, and is always the downlink carrier channel quality report volume obtained through calculation before the random access procedure starts.

2. The plurality of bits used to indicate the downlink carrier channel quality report volume are the bits of the MAC layer.

The terminal device indicates the downlink carrier channel quality report volume by using the bits of the MAC layer in the MSG3. According to an existing stipulation, a value of the bits of the MAC layer in the MSG3 is determined after the terminal device receives the MSG2 for the first time in the random access procedure, and the bits of the MAC layer in the MSG3 cannot be modified subsequently in the random access procedure once the bits are set. During obtaining of the downlink carrier channel quality report volume, the terminal device obtains a downlink multicast channel quality report volume by performing measurement on a first carrier. The process may be performed after the terminal device sends the MSG1 for the first time.

However, the following problem that may arise has been considered in this embodiment of this application:

In a random access procedure, a terminal device is allowed to make a plurality of random access attempts. In a random access attempt included in the random access procedure, when successfully receiving an RAR for the first time, the terminal device stores a MAC protocol data unit (PDU) corresponding to an MSG3 in an MSG3 buffer, that is, stores MAC layer information corresponding to the MSG3 in the MSG3 buffer. The random access attempt in which the terminal device receives the RAR successfully for the first time may be the first random access attempt in the random access procedure, or may be a subsequent random access attempt in the random access procedure. A current random access attempt may fail due to reasons such as a conflict resolution failure, and a quantity of random access attempts has not exceeded a stipulated maximum quantity of attempts. In this case, the terminal device may make a random access attempt again; and in all subsequent random access attempts, the terminal device will continue to use the MAC PDU stored in the MSG3. In other words, a transport block (TB) for transmitting an MSG3 is not changed in the random access procedure.

According to this manner, if the terminal device indicates a downlink channel quality report volume by using an MSG3, this means that the downlink channel quality report volume is not changed in the random access procedure either. If a plurality of random access attempts are made in the random access procedure, the downlink channel quality report volume indicated by the MSG3 always corresponds to a downlink channel quality report volume obtained when the RAR is received successfully for the first time. Consequently, a downlink carrier channel quality report volume cannot reflect actual downlink channel quality of a downlink carrier after the random access procedure is completed.

FIG. 5 is a schematic diagram of two random access attempts in a same random access procedure. In the figure, a random access attempt 1 corresponds to a random access attempt in which a terminal device receives an RAR successfully for the first time. For example, a downlink carrier channel quality report volume indicated in an MSG3 is Q. After the random access attempt 1 fails, if a quantity of random access attempts has not reached a stipulated maximum quantity of random access attempts in the current random access procedure, the terminal device makes a random access attempt again. In a subsequent random access attempt 2, a downlink carrier channel quality report volume indicated by an MSG3 is not changed, and is still Q. A very long time may have elapsed from the random access attempt 1 to the random access attempt 2, but the downlink carrier channel quality report volume indicated to a network device by the terminal device is always a value obtained previously through calculation. Consequently, the downlink carrier channel quality report volume may be unable to reflect a channel attenuation status and the like in a subsequent random access attempt in a timely manner.

Considering this problem, it is proposed in this embodiment of this application that a downlink carrier channel quality report volume indicated by an MSG3 may be changed in a random access procedure.

For example, after generating a downlink carrier channel quality report volume and before sending an MSG3 to a network device, a terminal device may update the generated downlink carrier channel quality report volume. After generating the downlink carrier channel quality report volume and before sending the MSG3 to the network device, the terminal device receives an MSG2 from the network device. In addition, an MSG3 buffer has stored a MAC PDU, and the MAC PDU includes a bit used to indicate the downlink carrier channel quality report volume. For example, the MAC PDU indicates the downlink carrier channel quality report volume by using a MAC CE. In this case, the terminal device may update the MAC CE that is included in the MAC PDU and that is used to indicate the downlink carrier channel quality report volume. In other words, the terminal device may update the downlink carrier channel quality report volume, adds an updated downlink carrier channel quality report volume to the MSG3, and then sends the MSG3 to the network device. In this manner, the downlink carrier channel quality report volume is updated, so that the downlink carrier channel quality report volume indicated by the terminal device can more accurately reflect a current channel attenuation status and the like in a relatively timely manner.

If a mechanism for updating the downlink carrier channel quality report volume is used, the terminal device receives the MSG2 from the network device, and the MSG3 buffer has stored the MAC PDU, where the MAC PDU includes the bit used to indicate the downlink carrier channel quality report volume. In this way, the terminal device may obtain a new downlink carrier channel quality report volume. For example, for a manner of obtaining the downlink carrier channel quality report volume, refer to the manner described above in this embodiment. Alternatively, the new downlink carrier channel quality report volume may be calculated in another manner, and the downlink carrier channel quality report volume indicated by the MSG3 may be updated based on the new downlink carrier channel quality report volume obtained through calculation.

If such a mechanism for updating the downlink carrier channel quality report volume is applied, the terminal device may indicate the downlink carrier channel quality report volume by using the bits in the MAC layer of the MSG3, because if the terminal device indicates the downlink carrier channel quality report volume by using the bits in the RRC layer of the MSG3, it is still difficult to update the downlink carrier channel quality report volume in the random access procedure. For example, the downlink carrier channel quality report volume is calculated in the manner in the embodiment shown in FIG. 3, that is, calculated based on the first number of repetitions and the second number of repetitions. In this case, the value of the bits of the MAC layer in the MSG3 may be determined after the MSG2 is received in the random access procedure, and is not changed in a subsequent step in the random access procedure. Alternatively, according to the solution proposed in this embodiment of this application, the value of the bits of the MAC layer in the MSG3 may be changed in the random access procedure.

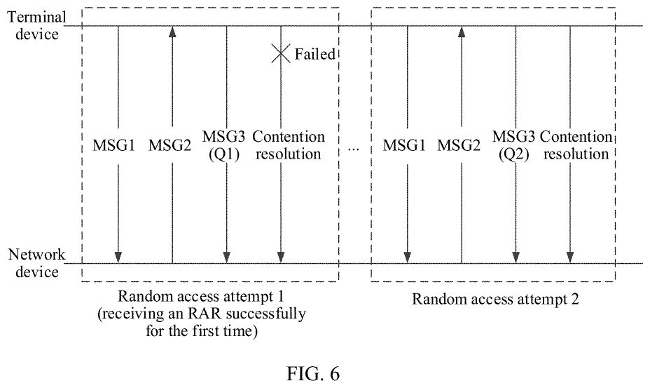

FIG. 6 is a schematic diagram of two random access attempts in a same random access procedure. In the figure, a random access attempt 1 corresponds to a random access attempt in which a terminal device receives an RAR successfully for the first time. For example, a downlink carrier channel quality report volume indicated in an MSG3 is Q1. After the random access attempt 1 fails, if a quantity of random access attempts has not reached a stipulated maximum quantity of random access attempts in the current random access procedure, the terminal device makes a random access attempt again. In a subsequent random access attempt 2, a downlink carrier channel quality report volume indicated by an MSG3 is changed, and is updated to Q2. In this way, the downlink carrier channel quality report volume Q2 can reflect a channel attenuation status and the like in the subsequent random access attempt in a relatively timely manner, so that the downlink carrier channel quality report volume obtained by the network device is more accurate.

As described above, the preset state of the plurality of bits in the MSG3 may be used for future extended application. In this case, an extension manner may be as follows: The terminal device indicates the downlink carrier channel quality report volume by using a non-all-0 state of the bits of the MAC layer or the bits of the RRC layer of the plurality of bits in a current version, where a preset non-all-0 state (that is, the preset state) represents support for future version extension. For example, in the current version, the terminal device and the network device never indicate the downlink carrier channel quality report volume by using the preset state; but in a future version, the terminal device may set the preset state to represent that the MSG3 further includes a plurality of extended bits, where the plurality of extended bits may be an extension of a function of the current version. For example, the plurality of extended bits may indicate a finer-grained downlink carrier channel quality report volume. In the future version, the network device determines, based on whether the preset state is used in the MSG3, whether to read the plurality of extended bits.

In addition, considering that the MSG3 not only may be used to indicate the downlink carrier channel quality report volume, but also may be used to indicate a power headroom level of an enhanced PH, if a quantity of idle bits in the MSG3 is less than a sum of a quantity of bits used to indicate the downlink carrier channel quality report volume and a quantity of bits used to indicate the power headroom level of the enhanced PH, a mechanism for determining how the MSG3 indicates the downlink carrier channel quality report volume and the power headroom level of the enhanced PH is needed. Related content will be detailed in the embodiment shown in FIG. 7, and therefore, is not described herein. For details, refer to related descriptions in the embodiment shown in FIG. 7 below.

In addition, in the embodiment shown in FIG. 7, descriptions will be provided based on a concept of “downlink channel quality report volume”. If the embodiment shown in FIG. 7 is combined with the embodiment shown in FIG. 3, the concept of “downlink channel quality report volume” in the embodiment shown in FIG. 3 is the same as the concept of “downlink channel quality report volume” in the embodiment shown in FIG. 7. If the embodiment shown in FIG. 7 is combined with the embodiment shown in FIG. 4, the concept of “downlink carrier channel quality report volume” in the embodiment shown in FIG. 4 can be considered as the same as the concept of “downlink channel quality report volume” in the embodiment shown in FIG. 7.

The embodiments of this application provide implementations on how a terminal device indicates a downlink carrier channel quality report volume by using an MSG3. This is more conducive to implementation by a person skilled in the art.

Besides the embodiments described above, the following problem is further considered in the embodiments of this application: In a current NB-IoT system, a TB size of an MSG3 is fixedly 88 bits, so that a quantity of idle bits in the MSG3 is limited. Moreover, according to the solutions provided in the embodiments of this application, the idle bits in the MSG3 not only need to indicate a downlink channel quality report volume (or a downlink carrier channel quality report volume, where the concept of downlink channel quality report volume is used for description below), but also may need to indicate a power headroom level of an enhanced PH. For details about the enhanced PH, refer to descriptions above. Details are not described herein again. In this case, if the MSG3 not only needs to indicate the downlink channel quality report volume, but also needs to indicate the power headroom level of the enhanced PH, there are two cases. In one case, the quantity of the idle bits in the MSG3 is greater than or equal to a sum of a quantity of bits used to indicate the downlink channel quality report volume and a quantity of bits used to indicate the power headroom level of the enhanced PH, the downlink channel quality report volume and the power headroom level of the enhanced PH may be directly indicated by using the MSG3. However, if the quantity of the idle bits in the MSG3 is less than the sum of the quantity of bits used to indicate the downlink channel quality report volume and the quantity of bits used to indicate the power headroom level of the enhanced PH, a mechanism for determining how the MSG3 indicates the downlink channel quality report volume and the power headroom level of the enhanced PH is needed. In view of this, the embodiments of this application further provide a technical solution to resolve this problem.

As shown in FIG. 7, an embodiment of this application provides a third information sending and receiving method. The process of the method is described below.

S71. A terminal device determines to-be-sent information, where the to-be-sent information is one of a downlink channel quality report volume and a power headroom level, and the downlink channel quality report volume is used to represent downlink channel quality of the terminal device.

In this embodiment of this application, the terminal device may determine the to-be-sent information in a plurality of different manners. The following describes several optional manners.

1. Determine the to-be-sent information based on a priority.

The terminal device determines, as the to-be-sent information, one of the downlink channel quality report volume and the power headroom level that has a higher priority, where a priority of the downlink channel quality report volume is higher than a priority of the power headroom level, or the priority of the power headroom level is higher than the priority of the downlink channel quality report volume.

In other words, the priority of the downlink channel quality report volume and the priority of the power headroom level of the enhanced PH are stipulated in advance, and the terminal device reports the information that has a higher priority. For example, it is stipulated that the priority of the downlink channel quality report volume is higher than the priority of the power headroom level of the enhanced PH. In this case, the terminal device determines that the to-be-sent information is the downlink channel quality report volume. Alternatively, it is stipulated that the priority of the power headroom level of the enhanced PH is higher than the priority of the downlink channel quality report volume. In this case, the terminal device determines that the to-be-sent information is the power headroom level of the enhanced PH. If a priority of one type of information is higher, it indicates that the information may be more important. In this case, the terminal device chooses to report the information that has a higher priority, so that the important information can be transmitted in a relatively timely manner.

The priority of the downlink channel quality report volume and the priority of the power headroom level of the enhanced PH may be stipulated by a protocol, or may be notified to the terminal device by a network device. This is not specifically limited.

2. The to-be-sent information is indicated by using some bits of a plurality of bits in an MSG3.

Before sending, to a network device, an MSG3 in a random access procedure, the terminal device may set a state of some bits in the plurality of bits based on the to-be-sent information, where the state of the some bits is used to indicate that the to-be-sent information is the downlink channel quality report volume or the power headroom level.

In other words, the terminal device may choose to report the downlink channel quality report volume or the power headroom level. For example, the terminal device may choose the downlink channel quality report volume or the power headroom level randomly, or the terminal device may choose to report the downlink channel quality report volume and the power headroom level in turn. For example, the terminal device first chooses to report the downlink channel quality report volume, and next time, chooses to report the power headroom level. Alternatively, the terminal device may use another choosing manner. The choice is made by the terminal device. Therefore, the terminal device may indicate to the network device by using some bits in the plurality of bits, based on whether remaining bits of the plurality of bits in the MSG3 (remaining bits other than the some bits) indicate the downlink channel quality report volume or the power headroom level. For example, the state of the some bits may be used to indicate whether the to-be-sent information is the downlink channel quality report volume or the power headroom level. After receiving the MSG3, the network device may determine, based on the state of the some bits in the plurality of bits, whether the terminal device indicates the downlink channel quality report volume or the power headroom level by using the MSG3. In this way, the terminal device can be kept consistent with the network device.

A quantity of the some bits is 1, for example, or may be a larger number. A location of the some bits in the plurality of bits is not limited in this embodiment of this application either.

3. Determine the to-be-sent information based on an indication from a network device.

The network device sends indication information to the terminal device, and the terminal device receives the indication information from the network device. The terminal device can determine, based on the indication information, whether the to-be-sent information is the downlink channel quality report volume or the power headroom level.

In other words, the network device instructs, by using the indication information, the terminal device to report the downlink channel quality report volume or the power headroom level. The terminal device can determine, based on the indication information sent by the network device, whether to report the downlink channel quality report volume or the power headroom level. The indication information may be implemented by using a system message or implemented by using an MSG2 in a random access procedure, or may be implemented by using another message. In this way, the terminal device can be kept consistent with the network device. In addition, the information that the network device instructs the terminal device to report may be information just required by the network device, and the terminal device reporting the information based on the instruction from the network device can also make the reported information more compliant with a requirement of the network device.

The terminal device may obtain the downlink channel quality report volume in a manner provided in the embodiments of this application. For details, refer to related descriptions in the embodiment shown in FIG. 3 or related descriptions about obtaining the downlink carrier channel quality report volume in the embodiment shown in FIG. 4. Alternatively, the terminal device may obtain the downlink channel quality report volume in another manner. For example, the terminal device may directly use, as the downlink channel quality report volume, the first number of repetitions in the embodiment shown in FIG. 3 or the embodiment shown in FIG. 4. In this case, for a manner of obtaining the first number of repetitions by the terminal device, also refer to related descriptions in the embodiment shown in FIG. 3 or the embodiment shown in FIG. 4. Alternatively, the terminal device may obtain the downlink channel quality report volume in another manner that is not mentioned in the embodiments of this application. This is not specifically limited.

S72. The terminal device sends the MSG3 to the network device in the random access procedure, and the network device receives the MSG3 from the terminal device, where the plurality of bits in the MSG3 are used to indicate the to-be-sent information.

S73. The network device determines the to-be-sent information based on a state of the plurality of bits in the MSG3, where the to-be-sent information is one of the downlink channel quality report volume and the power headroom level, and the downlink channel quality report volume is used to represent the downlink channel quality of the terminal device.

The terminal device may send the MSG3 to the network device after determining the to-be-sent information, where the plurality of bits in the MSG3 are used to indicate the to-be-sent information, so that after receiving the MSG3, the network device can obtain the downlink channel quality report volume or the power headroom level indicated by the terminal device.

It can be learned from the foregoing descriptions that if both the downlink channel quality report volume and the power headroom level of the enhanced PH need to be reported, this embodiment of this application provides a solution, to avoid a conflict and ensure, as far as possible, that at least one of the downlink channel quality report volume and the power headroom level of the enhanced PH can be reported normally.

The embodiment shown in FIG. 3, the embodiment shown in FIG. 4, and the embodiment shown in FIG. 7 that are described above may be considered as three independent embodiments and implemented separately, or may be considered as an integral part in which content in the embodiments can be mutually referenced and support each other.

With reference to the accompanying drawings, the following describes apparatuses provided in the embodiments of this application.

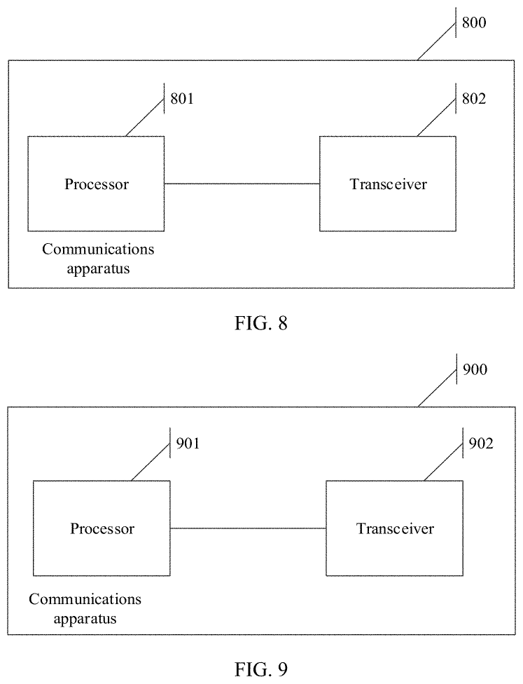

FIG. 8 is a schematic structural diagram of a communications apparatus 800. The communications apparatus 800 may implement a function of the terminal device described above. The communications apparatus 800 may be the terminal device described above, or may be a chip disposed in the terminal device described above. The communications apparatus 800 may include a processor 801 and a transceiver 802. For example, the transceiver 802 may be implemented through a radio frequency transceiver. The processor 801 may be configured to perform S31 in the embodiment shown in FIG. 3, and/or configured to support another process of the technologies described in this specification. The transceiver 802 may be configured to perform S32 in the embodiment shown in FIG. 3, and/or configured to support another process of the technologies described in this specification.

For example, the processor 801 is configured to generate a downlink channel quality report volume, where the downlink channel quality report volume is used to indicate a relative relationship between a first number of repetitions and a second number of repetitions, the first number of repetitions is a quantity of retransmissions that need to be performed in a preset downlink control channel format to achieve a preset block error rate, and the second number of repetitions is a number of repetitions corresponding to common search space of a downlink control channel carried on a downlink carrier.

The transceiver 802 is configured to send, to a network device, an MSG3 in a random access procedure, where the MSG3 is used to indicate the downlink channel quality report volume.

All related content in the steps in the foregoing method embodiments can be cited in function descriptions of corresponding function modules. Details are not described herein again.

FIG. 9 is a schematic structural diagram of a communications apparatus 900. The communications apparatus 900 may implement a function of the network device described above. The communications apparatus 900 may be the network device described above, or may be a chip or another component disposed in the network device described above. The communications apparatus 900 may include a processor 901 and a transceiver 902. For example, the transceiver 902 may be implemented through a radio frequency transceiver. The processor 901 may be configured to perform S33 in the embodiment shown in FIG. 3, and/or configured to support another process of the technologies described in this specification. The transceiver 902 may be configured to perform S32 in the embodiment shown in FIG. 3, and/or configured to support another process of the technologies described in this specification.

For example, the transceiver 902 is configured to receive, from a terminal device, an MSG3 in a random access procedure.

The processor 901 is configured to obtain a downlink channel quality report volume indicated by the MSG3, where the downlink channel quality report volume is used to indicate a relative relationship between a first number of repetitions and a second number of repetitions, the first number of repetitions is a quantity of retransmissions that need to be performed in a preset downlink control channel format to achieve a preset block error rate, and the second number of repetitions is a number of repetitions corresponding to common search space of a downlink control channel carried on a downlink carrier.

All related content in the steps in the foregoing method embodiments can be cited in function descriptions of corresponding function modules. Details are not described herein again.

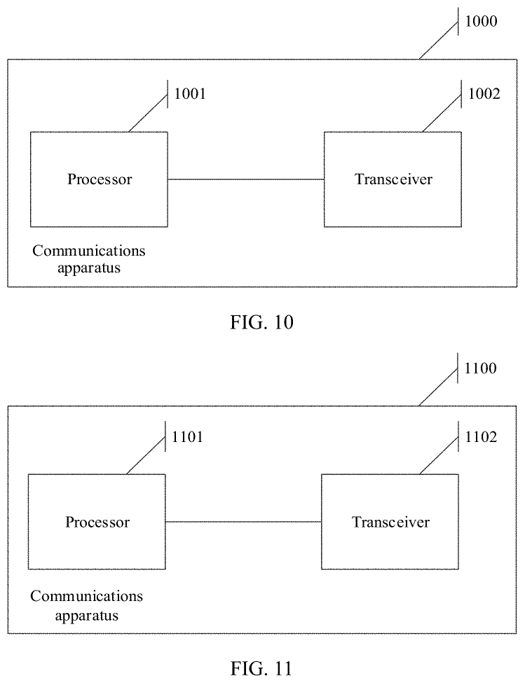

FIG. 10 is a schematic structural diagram of a communications apparatus 1000. The communications apparatus 1000 may implement a function of the terminal device described above. The communications apparatus 1000 may be the terminal device described above, or may be a chip or another component disposed in the terminal device described above. The communications apparatus 1000 may include a processor 1001 and a transceiver 1002. For example, the transceiver 1002 may be implemented through a radio frequency transceiver. The processor 1001 may be configured to perform S41 in the embodiment shown in FIG. 4, and/or configured to support another process of the technologies described in this specification. The transceiver 1002 may be configured to perform S42 in the embodiment shown in FIG. 4, and/or configured to support another process of the technologies described in this specification.

For example, the processor 1001 is configured to generate a downlink carrier channel quality report volume, where the downlink carrier channel quality report volume is used to represent channel quality of a downlink carrier.

The transceiver 1002 is configured to send, to a network device, an MSG3 in a random access procedure, where a plurality of bits in the MSG3 are used to indicate the downlink carrier channel quality report volume, and a state of the plurality of bits is a non-all-zeroed state.

Alternatively, for example, the processor 1001 is configured to: generate an MSG3 in a random access procedure, and set a state of a plurality of bits in the MSG3 to an all-zeroed state based on a preset condition, where the all-zeroed state is used to indicate that reporting of channel quality of a downlink carrier is not supported, or used to indicate that the channel quality of the downlink carrier is not reported this time.

The transceiver 1002 is configured to send the MSG3 to a network device.

All related content in the steps in the foregoing method embodiments can be cited in function descriptions of corresponding function modules. Details are not described herein again.

FIG. 11 is a schematic structural diagram of a communications apparatus 1100. The communications apparatus 1100 may implement a function of the network device described above. The communications apparatus 1100 may be the network device described above, or may be a chip or another component disposed in the network device described above. The communications apparatus 1100 may include a processor 1101 and a transceiver 1102. For example, the transceiver 1102 may be implemented through a radio frequency transceiver. The processor 1101 may be configured to perform S43 in the embodiment shown in FIG. 4, and/or configured to support another process of the technologies described in this specification. The transceiver 1102 may be configured to perform S42 in the embodiment shown in FIG. 4, and/or configured to support another process of the technologies described in this specification.

For example, the transceiver 1102 is configured to receive, from a terminal device, an MSG3 in a random access procedure, where a state of a plurality of bits in the MSG3 is a non-all-zeroed state.

The processor 1101 is configured to determine, based on the state of the plurality of bits, a downlink carrier channel quality report volume indicated by the terminal device, where the downlink carrier channel quality report volume is used to represent channel quality of a downlink carrier.

Alternatively, for example, the transceiver 1102 is configured to receive, from a terminal device, an MSG3 in a random access procedure.

The processor 1101 is configured to: determine that a state of a plurality of bits in the MSG3 is an all-zeroed state; and determine, based on the all-zeroed state, that the terminal device does not support reporting of channel quality of a downlink carrier, or that the terminal device does not report the channel quality of the downlink carrier this time.

All related content in the steps in the foregoing method embodiments can be cited in function descriptions of corresponding function modules. Details are not described herein again.

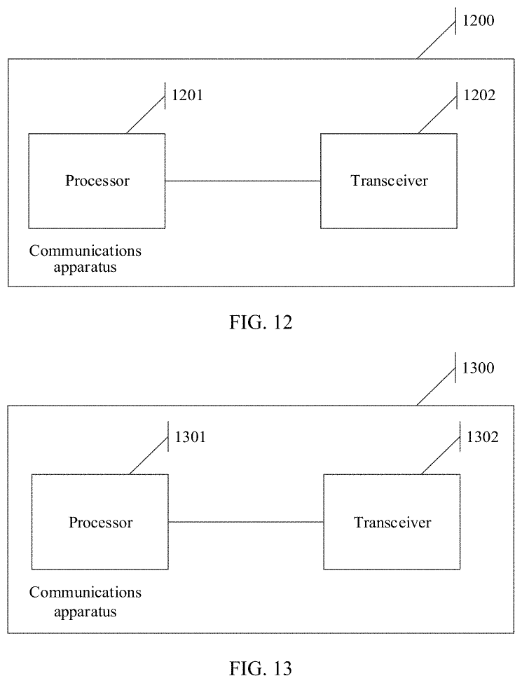

FIG. 12 is a schematic structural diagram of a communications apparatus 1200. The communications apparatus 1200 may implement a function of the terminal device described above. The communications apparatus 1200 may be the terminal device described above, or may be a chip or another component disposed in the terminal device described above. The communications apparatus 1200 may include a processor 1201 and a transceiver 1202. For example, the transceiver 1202 may be implemented through a radio frequency transceiver. The processor 1201 may be configured to perform S71 in the embodiment shown in FIG. 7, and/or configured to support another process of the technologies described in this specification. The transceiver 1202 may be configured to perform S72 in the embodiment shown in FIG. 7, and/or configured to support another process of the technologies described in this application.

For example, the processor 1201 is configured to determine to-be-sent information, where the to-be-sent information is one of a downlink channel quality report volume and a power headroom level, and the downlink channel quality report volume is used to represent downlink channel quality.

The transceiver 1202 is configured to send, to a network device, an MSG3 in a random access procedure, where a plurality of bits in the MSG3 are used to indicate the to-be-sent information.

All related content in the steps in the foregoing method embodiments can be cited in function descriptions of corresponding function modules. Details are not described herein again.

FIG. 13 is a schematic structural diagram of a communications apparatus 1300. The communications apparatus 1300 may implement a function of the network device described above. The communications apparatus 1300 may be the network device described above, or may be a chip or another component disposed in the network device described above. The communications apparatus 1300 may include a processor 1301 and a transceiver 1302. For example, the transceiver 1302 may be implemented through a radio frequency transceiver. The processor 1301 may be configured to perform S73 in the embodiment shown in FIG. 7, and/or configured to support another process of the technologies described in this application. The transceiver 1302 may be configured to perform S72 in the embodiment shown in FIG. 7, and/or configured to support another process of the technologies described in this application.

For example, the transceiver 1302 is configured to receive, from a terminal device, an MSG3 in a random access procedure.

The processor 1301 is configured to determine, based on a state of a plurality of bits in the MSG3, whether to-be-sent information indicated by the MSG3 is a downlink channel quality report volume or a power headroom level, where the downlink channel quality report volume is used to represent downlink channel quality of the terminal device.

All related content in the steps in the foregoing method embodiments can be cited in function descriptions of corresponding function modules. Details are not described herein again.

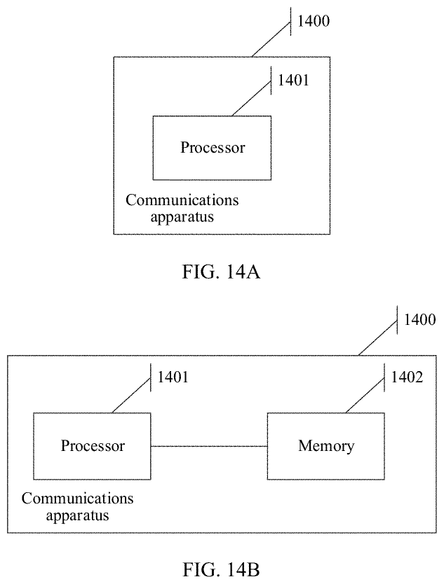

In a simple embodiment, a person skilled in the art may figure out that the communications apparatus 800, the communications apparatus 900, the communications apparatus 1000, the communications apparatus 1100, the communications apparatus 1200, or the communications apparatus 1300 may be implemented through a structure of a communications apparatus 1400 shown in FIG. 14A. The communications apparatus 1400 may implement a function of the network device or the terminal device described above. The communications apparatus 1400 may include a processor 1401.

When the communications apparatus 1400 is configured to implement a function of the terminal device in the embodiment shown in FIG. 3, the processor 1401 may be configured to perform S31 in the embodiment shown in FIG. 3, and/or support another process of the technologies described in this application. When the communications apparatus 1400 is configured to implement a function of the network device in the embodiment shown in FIG. 3, the processor 1401 may be configured to perform S33 in the embodiment shown in FIG. 3, and/or support another process of the technologies described in this application.

When the communications apparatus 1400 is configured to implement a function of the terminal device in the embodiment shown in FIG. 4, the processor 1401 may be configured to perform S41 in the embodiment shown in FIG. 4, and/or support another process of the technologies described in this application. When the communications apparatus 1400 is configured to implement a function of the network device in the embodiment shown in FIG. 4, the processor 1401 may be configured to perform S43 in the embodiment shown in FIG. 4, and/or support another process of the technologies described in this application.

When the communications apparatus 1400 is configured to implement a function of the terminal device in the embodiment shown in FIG. 7, the processor 1401 may be configured to perform S71 in the embodiment shown in FIG. 7, and/or support another process of the technologies described in this application. When the communications apparatus 1400 is configured to implement a function of the network device in the embodiment shown in FIG. 7, the processor 1401 may be configured to perform S73 in the embodiment shown in FIG. 7, and/or support another process of the technologies described in this application.

The communications apparatus 1400 may be implemented through a field programmable gate array (FPGA), an application-specific integrated chip (ASIC), a system on chip (SoC), a central processing unit (CPU), a network processor (NP), a digital signal processing circuit (DSP), a micro controller (MCU), a programmable controller (PLD), or another integrated chip. The communications apparatus 1400 may be disposed in the network device or the communications device in the embodiments of this application, to enable the network device or the communications device to implement the message transmission method provided in the embodiments of this application.

In an optional implementation, the communications apparatus 1400 may include a transceiver component, configured to communicate with another device. The transceiver component may also be understood as a communications interface, for example, a physical interface between the processor 1401 and a radio frequency transceiver apparatus. For example, when the communications apparatus 1400 is configured to implement a function of the network device or the terminal device in the embodiment shown in FIG. 3, the transceiver component may be configured to perform S32 in the embodiment shown in FIG. 3, and/or support another process of the technologies described in this application. When the communications apparatus 1400 is configured to implement a function of the network device or the terminal device in the embodiment shown in FIG. 4, the transceiver component may be configured to perform S42 in the embodiment shown in FIG. 4, and/or support another process of the technologies described in this application. When the communications apparatus 1400 is configured to implement a function of the network device or the terminal device in the embodiment shown in FIG. 7, the transceiver component may be configured to perform S72 in the embodiment shown in FIG. 7, and/or support another process of the technologies described in this application.

In an optional implementation, the communications apparatus 1400 may further include a memory 1402. Referring to FIG. 14B, the memory 1402 is configured to store computer programs or instructions, and the processor 1401 is configured to decode and execute the computer programs or the instructions. It should be understood that these computer programs or instructions may include function programs of the foregoing network device or the foregoing terminal device. When the function programs of the network device are decoded and executed by the processor 1401, the network device can implement functions of the network device in the method provided in the embodiment shown in FIG. 3, the embodiment shown in FIG. 4, or the embodiment shown in FIG. 7 in the embodiments of this application. When the function programs of the terminal device are decoded and executed by the processor 1401, the terminal device can implement functions of the terminal device in the method provided in the embodiment shown in FIG. 3, the embodiment shown in FIG. 4, or the embodiment shown in FIG. 7 in the embodiments of this application.

In another optional implementation, these function programs of the network device or the terminal device are stored in a memory outside the communications apparatus 1400. When the function programs of the network device are decoded and executed by the processor 1401, the memory 1402 temporarily stores some or all of content of the function programs of the network device. When the function programs of the terminal device are decoded and executed by the processor 1401, the memory 1402 temporarily stores some or all of content of the function programs of the terminal device.

In another optional implementation, these function programs of the network device or the terminal device are stored in the memory 1402 inside the communications apparatus 1400. When the memory 1402 inside the communications apparatus 1400 stores the function programs of the network device, the communications apparatus 1400 may be disposed in the network device in the embodiments of this application. When the memory 1402 inside the communications apparatus 1400 stores the function programs of the terminal device, the communications apparatus 1400 may be disposed in the terminal device in the embodiments of this application.

In still another optional implementation, some content of these function programs of the network device is stored in a memory outside the communications apparatus 1400, and other content of these function programs of the network device is stored in the memory 1402 inside the communications apparatus 1400. Alternatively, some content of these function programs of the terminal device is stored in a memory outside the communications apparatus 1400, and other content of these function programs of the terminal device is stored in the memory 1402 inside the communications apparatus 1400.

In the foregoing embodiments, the transceiver is configured to receive and send a signal. The processor is configured to control the transceiver to receive and send a signal and perform another processing function. Therefore, the transceiver is equivalent to an executor that receives and sends an air interface signal, and the processor is a controller that controls receiving and sending of the air interface signal, and is configured to schedule or control the transceiver to perform the receiving and sending. Driven by a software program or instruction in the memory, the processor controls the transceiver to receive and send various signals and implement the process of any one of the foregoing method embodiments. Therefore, one or both of the processor or transceiver may be considered to be capable of performing receiving and sending on an air interface.

In the embodiments of this application, the communications apparatus 800, the communications apparatus 900, the communications apparatus 1000, the communications apparatus 1100, the communications apparatus 1200, the communications apparatus 1300, and the communications apparatus 1400 are presented in a form in which each function module is obtained through division based on each function, or may be presented in a form in which each function module is obtained through division in an integrated manner. The “module” herein may be an ASIC, a processor and a memory that execute one or more software or firmware programs, an integrated logic circuit, and/or another component that can provide the foregoing functions.

In addition, the communications apparatus 800 provided in the embodiment shown in FIG. 8 may be alternatively implemented in another form. For example, the communications apparatus includes a processing module and a transceiver module. For example, the processing module may be implemented by the processor 801, and the transceiver module may be implemented by the transceiver 802. The processing module may be configured to perform S31 in the embodiment shown in FIG. 3, and/or configured to support another process of the technologies described in this application. The transceiver module may be configured to perform S32 in the embodiment shown in FIG. 3, and/or configured to support another process of the technologies described in this application.

For example, the processing module is configured to generate a downlink channel quality report volume, where the downlink channel quality report volume is used to indicate a relative relationship between a first number of repetitions and a second number of repetitions, the first number of repetitions is a quantity of retransmissions that need to be performed in a preset downlink control channel format to achieve a preset block error rate, and the second number of repetitions is a number of repetitions corresponding to common search space of a downlink control channel carried on a downlink carrier.

The transceiver module is configured to send, to a network device, an MSG3 in a random access procedure, where the MSG3 is used to indicate the downlink channel quality report volume.

All related content in the steps in the foregoing method embodiments can be cited in function descriptions of corresponding function modules. Details are not described herein again.

The communications apparatus 900 provided in the embodiment shown in FIG. 9 may be alternatively implemented in another form. For example, the communications apparatus includes a processing module and a transceiver module. For example, the processing module may be implemented by the processor 901, and the transceiver module may be implemented by the transceiver 902. The processing module may be configured to perform S33 in the embodiment shown in FIG. 3, and/or configured to support another process of the technologies described in this application. The transceiver module may be configured to perform S32 in the embodiment shown in FIG. 3, and/or configured to support another process of the technologies described in this application.

For example, the transceiver module is configured to receive, from a terminal device, an MSG3 in a random access procedure.

The processing module is configured to obtain a downlink channel quality report volume indicated by the MSG3, where the downlink channel quality report volume is used to indicate a relative relationship between a first number of repetitions and a second number of repetitions, the first number of repetitions is a quantity of retransmissions that need to be performed in a preset downlink control channel format to achieve a preset block error rate, and the second number of repetitions is a number of repetitions corresponding to common search space of a downlink control channel carried on a downlink carrier.

All related content in the steps in the foregoing method embodiments can be cited in function descriptions of corresponding function modules. Details are not described herein again.

The communications apparatus 1000 provided in the embodiment shown in FIG. 10 may be alternatively implemented in another form. For example, the communications apparatus includes a processing module and a transceiver module. For example, the processing module may be implemented by the processor 1001, and the transceiver module may be implemented by the transceiver 1002. The processing module may be configured to perform S41 in the embodiment shown in FIG. 4, and/or configured to support another process of the technologies described in this application. The transceiver module may be configured to perform S42 in the embodiment shown in FIG. 4, and/or configured to support another process of the technologies described in this application.

For example, the processing module is configured to generate a downlink carrier channel quality report volume, where the downlink carrier channel quality report volume is used to represent channel quality of a downlink carrier.

The transceiver module is configured to send, to a network device, an MSG3 in a random access procedure, where a plurality of bits in the MSG3 are used to indicate the downlink carrier channel quality report volume, and a state of the plurality of bits is a non-all-zeroed state.

Alternatively, for example, the processing module is configured to: generate an MSG3 in a random access procedure, and set a state of a plurality of bits in the MSG3 to an all-zeroed state based on a preset condition, where the all-zeroed state is used to indicate that reporting of channel quality of a downlink carrier is not supported, or used to indicate that the channel quality of the downlink carrier is not reported this time.

The transceiver module is configured to send the MSG3 to a network device.

All related content in the steps in the foregoing method embodiments can be cited in function descriptions of corresponding function modules. Details are not described herein again.

The communications apparatus 1100 provided in the embodiment shown in FIG. 11 may be alternatively implemented in another form. For example, the communications apparatus includes a processing module and a transceiver module. For example, the processing module may be implemented by the processor 1101, and the transceiver module may be implemented by the transceiver 1102. The processing module may be configured to perform S43 in the embodiment shown in FIG. 4, and/or configured to support another process of the technologies described in this application. The transceiver module may be configured to perform S42 in the embodiment shown in FIG. 4, and/or configured to support another process of the technologies described in this application.

For example, the transceiver module is configured to receive, from a terminal device, an MSG3 in a random access procedure, where a state of a plurality of bits in the MSG3 is a non-all-zeroed state.

The processing module is configured to determine, based on the state of the plurality of bits, a downlink carrier channel quality report volume indicated by the terminal device, where the downlink carrier channel quality report volume is used to represent channel quality of a downlink carrier.

Alternatively, for example, the transceiver module is configured to receive, from a terminal device, an MSG3 in a random access procedure.

The processing module is configured to: determine that a state of a plurality of bits in the MSG3 is an all-zeroed state; and determine, based on the all-zeroed state, that the terminal device does not support reporting of channel quality of a downlink carrier, or that the terminal device does not report the channel quality of the downlink carrier this time.

All related content in the steps in the foregoing method embodiments can be cited in function descriptions of corresponding function modules. Details are not described herein again.

The communications apparatus 1200 provided in the embodiment shown in FIG. 12 may be alternatively implemented in another form. For example, the communications apparatus includes a processing module and a transceiver module. For example, the processing module may be implemented by the processor 1201, and the transceiver module may be implemented by the transceiver 1202. The processing module may be configured to perform S71 in the embodiment shown in FIG. 7, and/or configured to support another process of the technologies described in this application. The transceiver module may be configured to perform S72 in the embodiment shown in FIG. 7, and/or configured to support another process of the technologies described in this application.

For example, the processing module is configured to determine to-be-sent information, where the to-be-sent information is one of a downlink channel quality report volume and a power headroom level, and the downlink channel quality report volume is used to represent downlink channel quality.

The transceiver module is configured to send, to a network device, an MSG3 in a random access procedure, where a plurality of bits in the MSG3 are used to indicate the to-be-sent information.

All related content in the steps in the foregoing method embodiments can be cited in function descriptions of corresponding function modules. Details are not described herein again.

The communications apparatus 1300 provided in the embodiment shown in FIG. 13 may be alternatively implemented in another form. For example, the communications apparatus includes a processing module and a transceiver module. For example, the processing module may be implemented by the processor 1301, and the transceiver module may be implemented by the transceiver 1302. The processing module may be configured to perform S73 in the embodiment shown in FIG. 7, and/or configured to support another process of the technologies described in this application. The transceiver module may be configured to perform S72 in the embodiment shown in FIG. 7, and/or configured to support another process of the technologies described in this application.

For example, the transceiver module is configured to receive, from a terminal device, an MSG3 in a random access procedure.

The processing module is configured to determine, based on a state of a plurality of bits in the MSG3, whether to-be-sent information indicated by the MSG3 is a downlink channel quality report volume or a power headroom level, where the downlink channel quality report volume is used to represent downlink channel quality of the terminal device.

All related content in the steps in the foregoing method embodiments can be cited in function descriptions of corresponding function modules. Details are not described herein again.

The communications apparatus 800, the communications apparatus 900, the communications apparatus 1000, the communications apparatus 1100, the communications apparatus 1200, the communications apparatus 1300, and the communications apparatus 1400 provided in the embodiments of this application may be configured to perform the method provided in the embodiment shown in FIG. 3, the embodiment shown in FIG. 4, or the embodiment shown in FIG. 7. Therefore, for technical effects that can be achieved by the communications apparatus 800, the communications apparatus 900, the communications apparatus 1000, the communications apparatus 1100, the communications apparatus 1200, the communications apparatus 1300, and the communications apparatus 1400, refer to the foregoing method embodiments. Details are not described herein again.

The embodiments of this application are described with reference to the flowcharts and/or block diagrams of the method, the device (system), and the computer program product according to the embodiments of this application. It should be understood that computer program instructions may be used to implement each process and/or each block in the flowcharts and/or the block diagrams and a combination of a process and/or a block in the flowcharts and/or the block diagrams. These computer program instructions may be provided for a general-purpose computer, a dedicated computer, an embedded processor, or a processor of another programmable data processing device to generate a machine, so that the instructions executed by the computer or the processor of the another programmable data processing device generate an apparatus for implementing a specific function in one or more processes in the flowcharts and/or in one or more blocks in the block diagrams.

All or some of the foregoing embodiments may be implemented by software, hardware, firmware, or any combination thereof. When software is used to implement the embodiments, all or some of the embodiments may be implemented in a form of a computer program product. The computer program product includes one or more computer instructions. When the computer program instructions are loaded and executed on a computer, the procedures or functions according to the embodiments of this application are all or partially generated. The computer may be a general-purpose computer, a dedicated computer, a computer network, or another programmable apparatus. The computer instructions may be stored in a computer-readable storage medium or may be transmitted from a computer-readable storage medium to another computer-readable storage medium. For example, the computer instructions may be transmitted from a website, computer, server, or data center to another website, computer, server, or data center in a wired (for example, a coaxial cable, an optical fiber, or a digital subscriber line (DSL)) or wireless (for example, infrared, radio, or microwave) manner. The computer-readable storage medium may be any usable medium accessible by a computer, or a data storage device, such as a server or a data center, integrating one or more usable media. The usable medium may be a magnetic medium (for example, a floppy disk, a hard disk, or a magnetic tape), an optical medium (for example, a digital versatile disc (DVD), a semiconductor medium (for example, a solid-state drive (SSD)), or the like.

It is clear that a person skilled in the art can make various modifications and variations to embodiments of this application without departing from the spirit and scope of this application. This application is intended to cover these modifications and variations provided that they fall within the scope of protection defined by the following claims and their equivalent technologies.

1. An information sending method, comprising:
generating a downlink channel quality report volume, wherein the downlink channel quality report volume indicates a relative relationship between a first number of repetitions and a second number of repetitions, the first number of repetitions is a quantity of retransmissions to be performed in a first downlink control channel format to achieve a preset block error rate, and the second number of repetitions is a number of repetitions for common search space of a downlink control channel carried on a downlink carrier; and
sending, to a network device, a third message (MSG3) in a random access procedure, wherein the MSG3 is used to indicate the downlink channel quality report volume.

2. The method according to claim 1, wherein the downlink carrier is a carrier for sending a second message (MSG2) in the random access procedure.

3. The method according to claim 2, wherein
the second number of repetitions is a maximum number of repetitions for common search space of the downlink control channel carried on the downlink carrier.

4. The method according to claim 1, further comprising:
before a first message (MSG1) in the random access procedure is sent, performing measurement on a downlink anchor carrier, to obtain the first number of repetitions.

5. The method according to claim 1, further comprising:
after an MSG1 in the random access procedure is sent, performing measurement on the downlink carrier for sending the MSG2 in the random access procedure, to obtain the first number of repetitions.

6. The method according to claim 1, wherein
the relative relationship represents a ratio between the first number of repetitions and the second number of repetitions, and the downlink channel quality report volume is a quantized value of the ratio.

7. The method according to claim 1, wherein
the relative relationship represents a value obtained by converting a ratio between the first number of repetitions and the second number of repetitions, and the downlink channel quality report volume is a quantized value of the value obtained through conversion.

8. The method according to claim 1, wherein a plurality of bits in the MSG3 are used to indicate the downlink channel quality report volume, and the plurality of bits are in a non-all-zeroed state.

9. An information receiving method, comprising:
receiving, from a terminal device, a third message (MSG3) in a random access procedure; and
obtaining a downlink channel quality report volume indicated by the MSG3, wherein the downlink channel quality report volume indicates a relative relationship between a first number of repetitions and a second number of repetitions, the first number of repetitions is a quantity of retransmissions to be performed in a first downlink control channel format to achieve a preset block error rate, and the second number of repetitions is a number of repetitions for common search space of a downlink control channel carried on a downlink carrier.

10. The method according to claim 9, wherein the downlink carrier is a carrier for sending a second message (MSG2) in the random access procedure.

11. The method according to claim 10, wherein
the second number of repetitions is a maximum number of repetitions for common search space of the downlink control channel carried on the downlink carrier.

12. The method according to claim 9, wherein
the relative relationship represents a ratio between the first number of repetitions and the second number of repetitions, and the downlink channel quality report volume is a quantized value of the ratio.

13. The method according to claim 9, wherein
the relative relationship represents a value obtained by converting a ratio between the first number of repetitions and the second number of repetitions, and the downlink channel quality report volume is a quantized value of the value obtained through conversion.

14. The method according to claim 9, wherein
a plurality of bits in the MSG3 are used to indicate the downlink channel quality report volume, and a state of the plurality of bits is a non-all-zeroed state.

15. A communications apparatus, comprising:
a memory storing program instructions; and
a processor coupled to the memory, wherein the program instructions, when executed by the processor, enable the apparatus to:
generate a downlink channel quality report volume, wherein the downlink channel quality report volume indicates a relative relationship between a first number of repetitions and a second number of repetitions, the first number of repetitions is a quantity of retransmissions to be performed in a first downlink control channel format to achieve a preset block error rate, and the second number of repetitions is a number of repetitions for common search space of a downlink control channel carried on a downlink carrier; and
send, to a network device, a third message (MSG3) in a random access procedure, wherein the MSG3 is used to indicate the downlink channel quality report volume.

16. The communications apparatus according to claim 15, wherein the downlink carrier is a carrier for sending a second message (MSG2) in the random access procedure.

17. The communications apparatus according to claim 16, wherein
the second number of repetitions is a maximum number of repetitions for common search space of the downlink control channel carried on the downlink carrier.

18. The communications apparatus according to claim 15, wherein the program instructions, when executed by the processor, further enable the apparatus to:
before sending a first message (MSG1) in the random access procedure, perform measurement on a downlink anchor carrier, to obtain the first number of repetitions.

19. The communications apparatus according to claim 15, wherein the program instructions, when executed by the processor, further enable the apparatus to:
after sending an MSG1 in the random access procedure, perform measurement on the downlink carrier for sending the MSG2 in the random access procedure, to obtain the first number of repetitions.

20. The communications apparatus according to claim 15, wherein
the relative relationship represents a ratio between the first number of repetitions and the second number of repetitions, and the downlink channel quality report volume is a quantized value of the ratio.

21. The communications apparatus according to claim 15, wherein
the relative relationship represents a value obtained by converting a ratio between the first number of repetitions and the second number of repetitions, and the downlink channel quality report volume is a quantized value of the value obtained through conversion.

22. The communications apparatus according to claim 15, wherein a plurality of bits in the MSG3 are used to indicate the downlink channel quality report volume, and the plurality of bits are in a non-all-zeroed state.

23. A communications apparatus, comprising:
a memory storing program instructions; and
a processor coupled to the memory, wherein the program instructions, when executed by the processor, enable the apparatus to:
receive, from a terminal device, a third message (MSG3) in a random access procedure; and
obtain a downlink channel quality report volume indicated by the MSG3, wherein the downlink channel quality report volume indicates a relative relationship between a first number of repetitions and a second number of repetitions, the first number of repetitions is a quantity of retransmissions to be performed in a first downlink control channel format to achieve a preset block error rate, and the second number of repetitions is a number of repetitions for common search space of a downlink control channel carried on a downlink carrier.

24. The communications apparatus according to claim 23, wherein the downlink carrier is a carrier for sending a second message (MSG2) in the random access procedure.

25. The communications apparatus according to claim 24, wherein
the second number of repetitions is a maximum number of repetitions for common search space of the downlink control channel carried on the downlink carrier.

26. The communications apparatus according to claim 23, wherein
the relative relationship represents a ratio between the first number of repetitions and the second number of repetitions, and the downlink channel quality report volume is a quantized value of the ratio.

27. The communications apparatus according to claim 23, wherein
the relative relationship represents a value obtained by converting a ratio between the first number of repetitions and the second number of repetitions, and the downlink channel quality report volume is a quantized value of the value obtained through conversion.

28. The communications apparatus according to claim 23, wherein
a plurality of bits in the MSG3 are used to indicate the downlink channel quality report volume, and a state of the plurality of bits is a non-all-zeroed state.
